(19) United States
(12) Patent Application Publication
(10) Pub. No.: US 2026/0253252 A1
(43) Pub. Date: Aug. 27, 2026

(54) INFORMATION PROCESSING DEVICE AND METHOD

(71) Applicant: SONY GROUP CORPORATION, TOKYO (JP)

(72) Inventor: KENJI KONDO, TOKYO (JP)

(21) Appl. No.: 19/162,066

(22) PCT Filed: Mar. 5, 2024
(86) PCT No.: PCT/JP2024/008213

§ 371 Date: Sep. 4, 2025

(30) Foreign Application Priority Data
Mar. 28, 2023 (JP) 2023-051461

(51) Int. Cl. G06T 7/73

(52) U.S. Cl. CPC G06T 7/74

(57) ABSTRACT

The present disclosure relates to an information processing device and a method that make it possible to suppress reduction in quality of reconstruction of a 3D scene and quality of rendering using the reconstruction. A camera pose is estimated for each of frames of a moving image obtained by imaging of an object, and learning is performed of a neural network that approximates a radiance field expressing a scene in a space including the object by a color in each of directions at each of positions in the space and opacity at each position in the space by using the moving image and the camera pose estimated. Alternatively, the object is imaged, additional information is generated to be used for one or both of the estimation of the camera pose and the learning of the neural network, and the additional information is added to the moving image and encoded. The present disclosure can be applied to, for example, an information processing device, an electronic device, an information processing method, a program, or the like.

### TECHNICAL FIELD

The present disclosure relates to an information processing device and a method, and more particularly, to an information processing device and a method enabled to suppress reduction in quality of reconstruction of a 3D scene and quality of rendering using the reconstruction.

### BACKGROUND ART

Conventionally, as a method of expressing a three-dimensional shape of an object, there has been NeRF (Representing Scenes as Neural Radiance Fields for View Synthesis) that generates a radiance field corresponding to a space including the object and approximates the radiance field with a neural network (see, for example, Non-Patent Documents 1 to 3). In NeRF learning, a still image has been used.

### CITATION LIST

### Non-Patent Document

Non-Patent Document 1: Ben Mildenhall, Pratul P. Srinivasan, Matthew Tancik, Jonathan T. Barron, Ravi Ramamoorthi, Ren Ng, “NeRF: Representing scenes as neural radiance fields for view synthesis”, ECCV 2020, 2020 Mar. 19
Non-Patent Document 2: Thomas Muller, Alex Evans, Christoph Schied, Alexander Keller, “Instant neural graphics primitives with a multiresolution hash encoding”, arXiv preprint arXiv: 2201.05989, 2022 Jan. 16
Non-Patent Document 3: Ricardo Martin-Brualla, Noha Radwan, Mehdi S. M. Sajjadi, Jonathan T. Barron, Alexey Dosovitskiy, Daniel Duckworth, “NeRF in the Wild: Neural Radiance Fields for Unconstrained Photo Collections”, https://arxiv.org/abs/2008.02268, 2020 Aug. 5

### SUMMARY OF THE INVENTION

### Problems to be Solved by the Invention

However, in the NeRF learning, accuracy of a camera pose is important, and there has been a possibility that quality of a learning result is reduced when the accuracy is low. In the case of a still image, there are few constraints such as a positional relationship between images, difficulty of camera pose estimation increases, and there has been a possibility that accuracy of the camera pose estimation is reduced. As a result, there has been a possibility that quality of reconstruction of a 3D scene and quality of rendering using the reconstruction are reduced.

The present disclosure has been made in view of such a situation, and an object thereof is to make it possible to suppress reduction in quality of reconstruction of a 3D scene and quality of rendering using the reconstruction.

### Solutions to Problems

An information processing device according to one aspect of the present technology is an information processing device including: a pose estimation unit that estimates a camera pose indicating a posture of a camera for each of frames of a moving image obtained by imaging of an object; and a learning unit that performs learning of a neural network that approximates a radiance field expressing a scene in a space including the object by a color in each of directions at each of positions in the space and opacity at each position in the space by using the moving image and the camera pose estimated, in which the pose estimation unit uses images of some consecutive frames of the moving image including a target frame for which the camera pose is estimated, as neighboring images captured in the vicinity of each other, and estimates the camera pose for the target frame.

An information processing method according to one aspect of the present technology is an information processing method including: estimating a camera pose indicating a posture of a camera for each of frames of a moving image obtained by imaging of an object to estimate the camera pose for a target frame by using images of some consecutive frames of the moving image including the target frame for which the camera pose is to be estimated as neighboring images captured in the vicinity of each other when estimating the camera pose for each frame; and performing learning of a neural network that approximates a radiance field expressing a scene in a space including the object by a color in each of directions at each of positions in the space and opacity at each position in the space by using the moving image and the camera pose estimated.

An information processing device according to another aspect of the present technology is an information processing device including: an imaging unit that images an object to generate a moving image; an additional information generation unit that generates additional information to be used for any one or both of estimation of a camera pose indicating a posture of a camera for each of frames of the moving image, and learning of a neural network that approximates a radiance field expressing a scene in a space including the object by a color in each of directions at each of positions in the space and opacity at each position in the space, to add the additional information to the moving image; and an encoding unit that encodes the moving image to which the additional information is added to generate a bit stream.

An information processing method according to another aspect of the present technology is an information processing method including: imaging an object to generate a moving image; generating additional information to be used for any one or both of estimation of a camera pose indicating a posture of a camera for each of frames of the moving image, and learning of a neural network that approximates a radiance field expressing a scene in a space including the object by a color in each of directions at each of positions in the space and opacity at each position in the space, to add the additional information to the moving image; and encoding the moving image to which the additional information is added to generate a bit stream.

In the information processing device and method according to one aspect of the present technology, a camera pose indicating a posture of a camera is estimated for each frame of a moving image obtained by imaging of an object, and when the camera pose for each frame is estimated, images of some consecutive frames of the moving image including a target frame for which the camera pose is estimated are used as neighboring images captured in the vicinity of each other, the camera pose for the target frame is estimated, and the moving image and the estimated camera pose are used to perform learning of a neural network that approximates a radiance field expressing a scene in a space including the object by a color in each direction at each position in the space and opacity of each position in the space.

In the information processing device and method according to another aspect of the present technology, an object is imaged, a moving image is generated, additional information is generated used for any one or both of estimation of a camera pose indicating a posture of a camera for each frame of the moving image and learning of a neural network that approximates a radiance field expressing a scene in a space including the object by a color in each direction at each position in the space and opacity of each position in the space, the additional information is added to the moving image, and the moving image to which the additional information is added is encoded to generate a bit stream.

### BRIEF DESCRIPTION OF DRAWINGS

FIG. 1 is a diagram for explaining NeRF.

FIG. 2 is a diagram illustrating an example of a model of a pinhole camera.

FIG. 3 is a diagram illustrating an example of models of lens distortion.

FIG. 4 is a diagram for explaining a radiance field.

FIG. 5 is a diagram for explaining direction dependency of light.

FIG. 6 is a diagram for explaining NeRF learning using a moving image.

FIG. 7 is a diagram for explaining characteristics of the moving image.

FIG. 8 is a diagram for explaining an example of neighboring images.

FIG. 9 is a diagram illustrating an example of a constraint of neighboring images.

FIG. 10 is a diagram illustrating an example of the constraint of the neighboring images.

FIG. 11 is a diagram illustrating an example of the constraint of the neighboring images.

FIG. 12 is a diagram illustrating an example of information regarding a rolling shutter.

FIG. 13 is a diagram illustrating an example of information regarding a range of a camera pose.

FIG. 14 is a diagram illustrating an example of information regarding the range of the camera pose.

FIG. 15 is a system diagram illustrating a main configuration example of an information processing system.

FIG. 16 is a block diagram illustrating a main configuration example of an imaging device.

FIG. 17 is a block diagram illustrating a main configuration example of an information processing device.

FIG. 18 is a flowchart explaining an example of a flow of imaging processing.

FIG. 19 is a flowchart explaining an example of a flow of learning processing.

FIG. 20 is a flowchart explaining an example of a flow of pose estimation processing.

FIG. 21 is a flowchart explaining an example of a flow of inference processing.

FIG. 22 is a block diagram illustrating a main configuration example of an imaging device.

FIG. 23 is a flowchart explaining an example of a flow of imaging learning processing.

FIG. 24 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be given in the following order.
1. Documents and the like supporting technical content and technical terms
2. NeRF learning using still image
3. NeRF learning using moving image
4. First embodiment (information processing system)
5. Second embodiment (imaging device)
6. Supplementary note

### 1. Documents and the Like Supporting Technical Content and Technical Terms

The scope disclosed in the present technology includes, in addition to the contents disclosed in the embodiment, the contents described in the following Non-Patent Documents and the like known at the time of filing, the contents of other documents referred to in following Non-Patent Documents and the like.
Non-Patent Document 1: (described above)
Non-Patent Document 2: (described above)
Non-Patent Document 3: (described above)
Non-Patent Document 4: Alex Yu, Vickie Ye, Matthew Tancik, Angjoo Kanazawa, “pixelNeRF: Neural Radiance Fields from One or Few Images”, https://arxiv.org/abs/2012.02190, 2020 Dec. 3
Non-Patent Document 5: Keunhong Park, Utkarsh Sinha, Peter Hedman, Jonathan T. Barron, Sofien Bouaziz, Dan B Goldman, Ricardo Martin-Brualla, Steven M. Seitz, “HyperNeRF: A Higher-Dimensional Representation for Topologically Varying Neural Radiance Fields”, https://arxiv.org/abs/2106.13228, 2021 Jan. 24

That is, the contents described in the above-described Non-Patent Documents, the contents of other documents referred to in the above-described Non-Patent Documents, and the like are also basis for determining the support requirement.

### 2. NeRF Learning Using Still Image

### <NeRF>

Conventionally, as a method of expressing a three-dimensional shape of an object, there is NeRF (Representing Scenes as Neural Radiance Fields for View Synthesis) that generates a radiance field corresponding to a space including the object and approximates the radiance field with a neural network.

The radiance field expresses a scene in a space including an object by a color in each of directions at each of positions in the space and opacity at each position in the space. Here, the opacity is an index indicating that there is some object, and can also be referred to as density. That is, it is possible to obtain a shape in a three-dimensional space by obtaining a radiance field in which the density of coordinates where there is an object is high. NeRF approximates such a radiance field with a neural network. That is, NeRF is a technology of generating a radiance field corresponding to a 3D object, approximating the radiance field with a neural network, and performing rendering using the neural network.

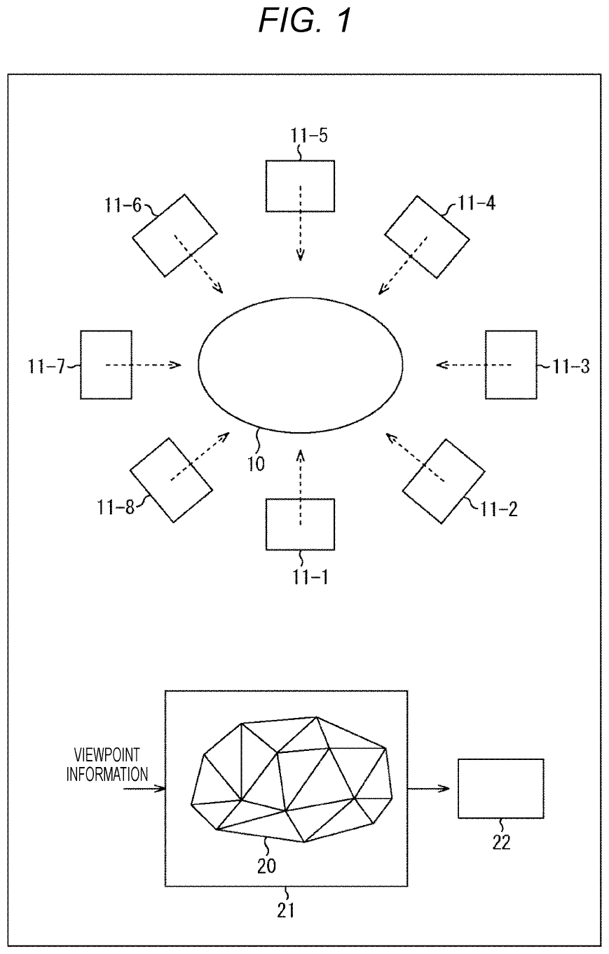

In NeRF, for example, as in captured images 11-1 to 11-8 in FIG. 1, an object 10 is imaged from positions different from each other, a camera pose is obtained for a captured image 11 obtained, and learning of the neural network is performed by using the captured image 11 and the camera pose, whereby a neural network 21 is generated that approximates a radiance field 20 representing the three-dimensional shape of the object 10. At the time of inference, pose information (also referred to as viewpoint information) on a desired new viewpoint is input to the neural network 21, whereby a rendered image 22 at the new viewpoint is obtained.

Note that, in the present specification, a posture (including a position and a direction) is also referred to as a pose. Furthermore, information indicating the pose is also referred to as pose information. A pose of an imaging unit (camera) that images a subject is also referred to as a camera pose. For example, a camera pose for a captured image indicates a pose of a camera that performs imaging for generating the captured image (a pose of the camera corresponding to the captured image). Furthermore, the learning of the neural network in ReNF is also referred to as NeRF learning.

### <Pose Estimation>

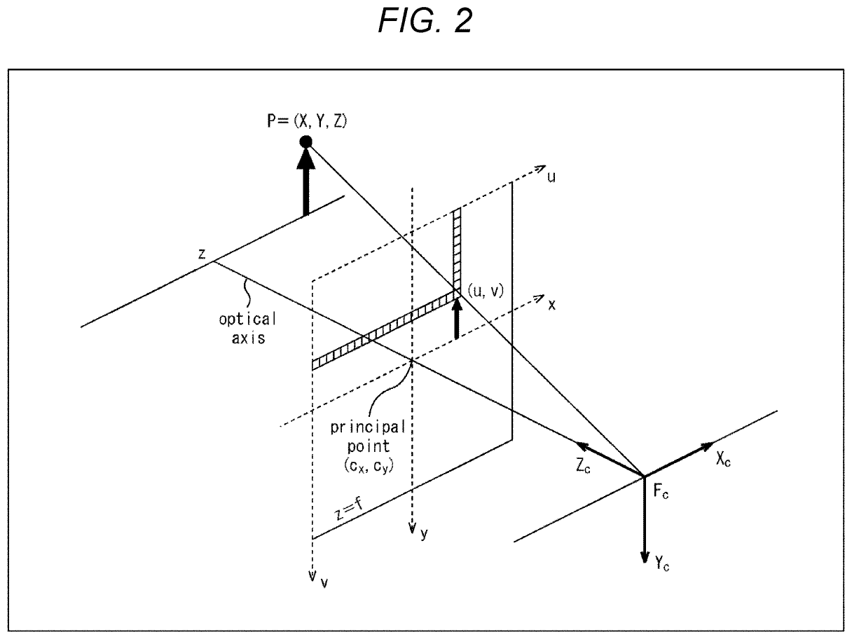

Next, estimation of a camera pose for a captured image will be described. FIG. 2 is a diagram illustrating an example of a model of a pinhole camera. In FIG. 2, Fc represents a pinhole. On a plane xy, uv indicates coordinates of the captured image. The model can be expressed as Expressions (1) and (2) below.

$${sm}^{′} = A [ R \vert t ] {M}^{′} \qquad ( 1 )$$

$$s [ \begin{matrix}u \\ v \\ l\end{matrix} ] = [ \begin{matrix}{f}_{\text{?}} & 0 & {c}_{\text{?}} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ] \qquad ( 2 )$$

$$\text{?} \text{indicates text missing or illegible when filed}$$

Here, in Expression (1), R represents a direction, and t represents a position. A symbol [R|t] is a matrix of camera external parameters, and corresponds to the camera pose. Furthermore, A indicates camera internal parameters. It is also referred to as a camera matrix or a matrix of built-in parameters. Furthermore, in Expression (2), rᵢⱼ represents a direction, and tᵢ represents a position. Coordinates (X, Y, Z) represent coordinates of a 3D point in a world coordinate space. Coordinates (u, v) represent coordinates (in units of pixels) of a projection point. Coordinates (cx, cy) usually represents the center (also referred to as a principal point) of the image. Symbols fx and fy indicate focal lengths expressed in units of pixels.

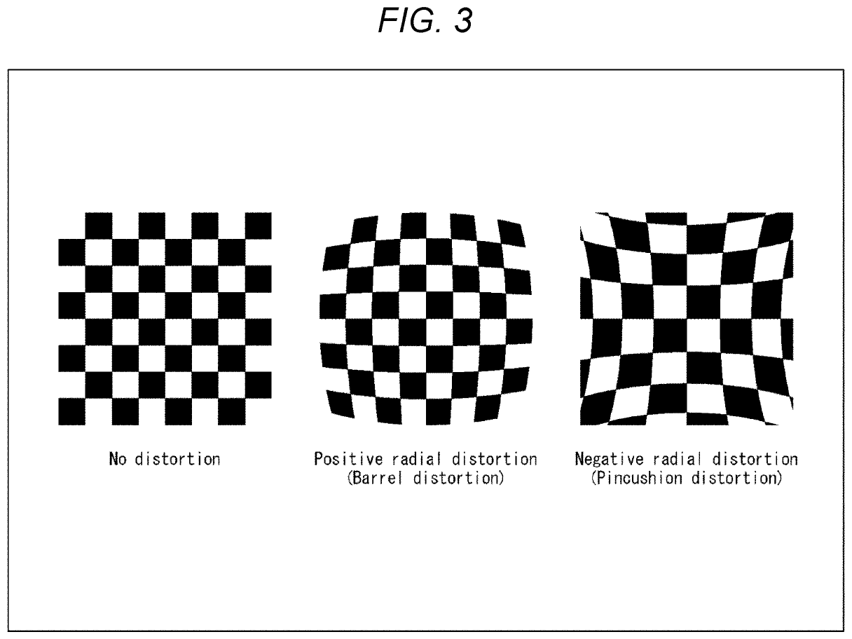

A lens is used in an actual camera, and lens distortion occurs in the captured image. FIG. 3 illustrates examples of the lens distortion. A model of the lens distortion can be expressed as Expressions (3) to (10) below.

$$[ \begin{matrix}x \\ y \\ z\end{matrix} ] = R [ \begin{matrix}X \\ Y \\ Z\end{matrix} ] + \text{?} \qquad ( 3 )$$

$${x}^{′} = x / z \qquad ( 4 )$$

$${y}^{′} = y / z \qquad ( 5 )$$

$${x}^{″} = {x}^{′} \frac{1 + {k}_{1} {r}^{2} + {k}_{2} {r}^{4} + {k}_{\text{?}} {r}^{6}}{1 + {k}_{4} {r}^{2} + {k}_{\text{?}} {r}^{4} + {k}_{6} {r}^{6}} + 2 {p}_{1} {x}^{′} {y}^{′} + {p}_{2} ( {r}^{2} + 2 {x}^{′2} ) \qquad ( 6 )$$

$${y}^{″} = {y}^{′} \frac{1 + {k}_{1} {r}^{2} + {k}_{2} {r}^{4} + {k}_{3} {r}^{6}}{1 + {k}_{4} {r}^{2} + {k}_{5} {r}^{4} + {k}_{6} {r}^{6}} + {p}_{1} ( {r}^{2} + 2 {y}^{′2} ) + 2 {p}_{2} {x}^{′} {y}^{′} \qquad ( 7 )$$

$$where {r}^{2} = {x}^{′2} + {y}^{′2} \qquad ( 8 )$$

$$u = {f}_{x} * {x}^{″} + {c}_{\text{?}} \qquad ( 9 )$$

$$v = {f}_{\text{?}} * {y}^{″} + {c}_{y} \qquad ( 10 )$$

$$\text{?} \text{indicates text missing or illegible when filed}$$

Here, k₁ to k₆ represent radial distortion coefficients. p₁ and p₂ represent tangential distortion coefficients. The left part of FIG. 3 illustrates an example of a state without distortion, the center part of FIG. 3 illustrates an example of barrel distortion (usually k₁>0), and the right part of FIG. 3 illustrates an example of pincushion distortion (usually k₁<0).

The estimation of the camera pose is performed by application of an algorithm, for example, structure from motion (SfM), visual simultaneous localization and mapping (Visual SLAM), or the like. For example, in the case of the SfM, camera internal parameters, camera external parameters (camera pose), and lens distortion parameters are estimated. In the SfM, open source software called COLMAP is often used. In the case of the SfM, processing is started not in real time but in a state where all the images are prepared. A Visual SLAM algorithm creates a camera position and map sequentially (in real time) while capturing images. In the SfM and Visual SLAM, the camera pose is estimated by bundle adjustment (also referred to as BA).

### <Learning (Optimization)>

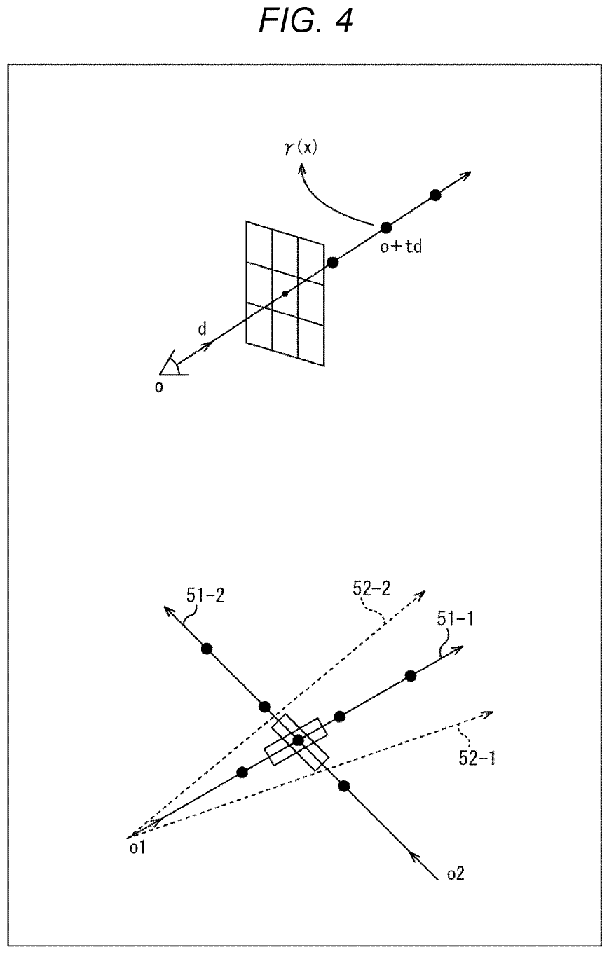

Next, learning (optimization) of the neural network will be described. The NeRF learning is performed on the basis of the following principle. In NeRF, a pixel value of a captured image is treated as a light beam detected by an element of an image sensor thereof. That is, as illustrated in the upper part of FIG. 4, it is considered that a color (that is, an object) detected by a pixel is present on a straight line connecting a camera position (focal position) o and the pixel of the captured image. A grid is an image (here, 3×3 pixels) and illustrates a state where the light beam passes through a pixel of the image. The light beam is characterized by the focal position o and a unit vector d indicating a direction. A period of sampling the space is represented by t. However, it is not possible to specify where the object is present on the straight line from one viewpoint. As illustrated in the lower part of FIG. 4, the position of the detected color is specified by use of intersection of light beams from viewpoints different from each other. A light beam 51-1 is a light beam that reaches a viewpoint o1, and a light beam 51-2 is a light beam that reaches a viewpoint o2. In a case where the same color is detected in the light beam 51-1 and the light beam 51-2, a possibility increases that the object is present at an intersection of the light beam 51-1 and the light beam 51-2. By using such a principle, it is possible to reconstruct a radiance field that more accurately expresses the three-dimensional shape of the object by analyzing the density for more viewpoints.

That is, in the NeRF learning, parameters of a multi-layer perceptron (MLP) and a voxel grid (Voxel Grid) are optimized by use of such a light beam as teacher data.

### <Rendering>

When a desired posture of the camera (new viewpoint) is set and pose information on the new viewpoint is input to the neural network of which learning is performed as described above, a rendered image at the new viewpoint (a virtual captured image captured in the desired posture) is output. Opacity σ and a color c required for volume rendering can be derived from the above-described parameters of MLP and voxel grid.

### <Reduction in Quality of Learning Result>

In NeRF, since learning is performed on the basis of the above principle, accuracy of the radiance field (3D model) (accuracy of the three-dimensional shape of the object to be expressed) depends on accuracy of the light beam as teacher data, that is, accuracy of the camera pose for the captured image. For example, in FIG. 4, when the light beam 51-1 is derived as a dotted arrow 52-1 or a dotted arrow 52-2 and learning is performed, a position of the intersection with the light beam 51-2 is shifted. For that reason, there has been a possibility that the accuracy of the radiance field is reduced. That is, when accuracy of pose estimation (estimation of the camera pose) is reduced, there has been a possibility that quality of a learning result (accuracy of the radiance field approximated by the neural network) is reduced. For that reason, there has been a possibility that quality of reconstruction of a 3D scene obtained by inference using the learned neural network and quality of rendering using the reconstruction is reduced.

By the way, conventionally, a still image has been used in the NeRF learning. In Non-Patent Document 3, it has also been considered to perform the NeRF learning with fewer captured images.

However, when the number of images is reduced, there has been a possibility that optimization of learning becomes more difficult due to expression of direction dependency of light (View-dependent). Furthermore, there has been a possibility that a possibility increases that a floater is generated in which an object is formed like mist is generated in the air where nothing should be present.

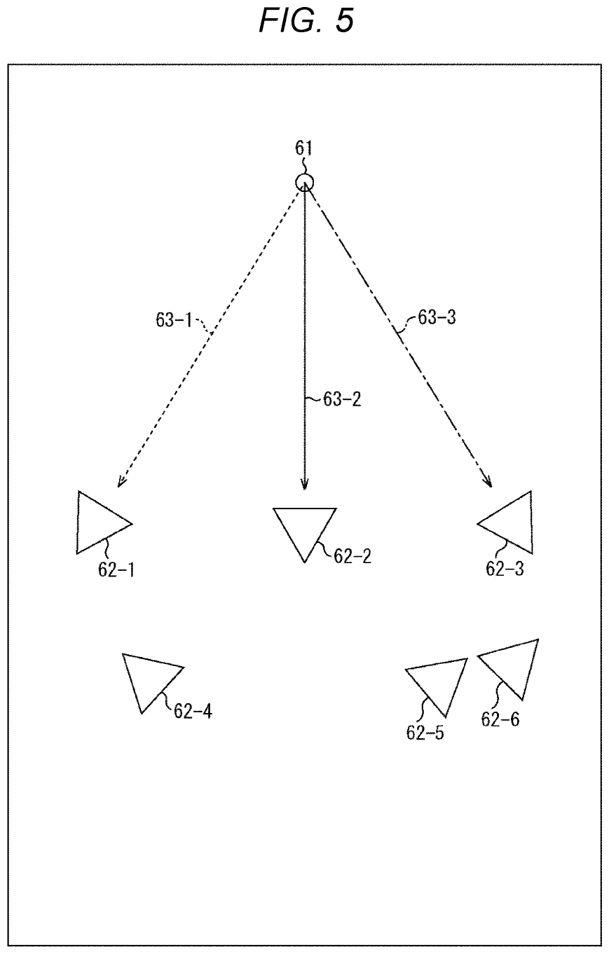

For example, as illustrated in FIG. 5, in a case where different colors are emitted depending on directions from a certain subject 61, colors different from each other may be detected in poses of a camera 62-1, a camera 62-2, and a camera 62-3 for the subject 61 (for example, blue, orange, green, and the like). For example, such a phenomenon is likely to occur in reflected light of a surface or a mirror surface of a compact disc (CD). In a case where the detected colors are different depending on the poses as described above, there has been a possibility that, in matching processing for the pose estimation, the subject 61 included in each of images by the camera 62-1, the camera 62-2, and the camera 62-3 is detected as a corresponding one of subjects different from each other, and matching cannot be performed. Furthermore, for example, it is assumed that learning is performed without using the image by the camera 62-2 for the learning, and matching between the images by the camera 62-1 and the camera 62-3 has succeeded. In that case, even if the pose of the camera 62-2 is input at the time of inference, it has been difficult to estimate the color (for example, orange) detected in the captured image by the camera 62-2 in the rendered image.

As described above, when the number of images is reduced, there has been a possibility that accuracy of a result of the NeRF learning is reduced. In other words, by increasing the number of images to be applied to learning, it is possible to suppress reduction in accuracy of a result of the learning. For example, in the example in FIG. 5, an overlap between the images increases in a case where the pose estimation or the learning is performed using also the captured images of the camera 62-2 than in a case where the pose estimation or the learning is performed using the captured images of the camera 62-1 and the camera 62-3, and thus, it is possible to suppress reduction in the accuracy of the result of the learning. By performing the pose estimation and the learning using also captured images by a camera 62-4 to a camera 62-6, it is possible to grasp how light changes depending on the pose in more detail, and thus, it is possible to further suppress reduction in the accuracy of the result of the learning.

However, since still images are independently generated (as different images), respectively, there is no constraint on a relationship between the images, such as a positional relationship. For that reason, it has been difficult to specify which image is closer to which image and which image is farther from which image, for example. For that reason, matching needs to be performed by treating all captured images similarly, and there has been a possibility that not only an amount of processing of matching increases, but also a possibility of occurrence of erroneous determination increases. That is, there has been a possibility that difficulty of the pose estimation increases, and the accuracy is reduced. As described above, when the accuracy of the pose estimation is reduced, there has been a possibility that the quality of the learning result (accuracy of the radiance field approximated by the neural network) is reduced. For that reason, there has been a possibility that quality of reconstruction of a 3D scene obtained by inference using the learned neural network and quality of rendering using the reconstruction is reduced.

### 3. NeRF Learning Using Moving Image

### <Application of Moving Image>

Thus, the NeRF learning is performed using a moving image. That is, the above-described pose estimation and learning are performed using a moving image.

For example, a first information processing device includes: a pose estimation unit that estimates a camera pose for each of frames of a moving image obtained by imaging of an object; and a learning unit that performs learning of a neural network that approximates a radiance field expressing a scene in a space including the object by a color in each of directions at each of positions in the space and opacity at each position in the space by using the moving image and the camera pose estimated. Note that the pose estimation unit may further estimate camera internal parameters. Furthermore, in a first information processing method, a camera pose is estimated for each of frames of a moving image obtained by imaging of an object, and learning is performed of a neural network that approximates a radiance field expressing a scene in a space including the object by a color in each of directions at each of positions in the space and opacity at each position in the space by using the moving image and the camera pose estimated. Note that not only the camera pose but also camera internal parameters may be estimated.

### <Moving Image>

Note that, in the present specification, a moving image indicates a group of images that can be continuously displayed (at a predetermined frame rate). In other words, the moving image indicates a group of images in which the display order of each image can be identified. For example, the group of images may be arranged in a display order as frames and collected in one file (one sequence). In that case, the arrangement order of the images indicates the display order.

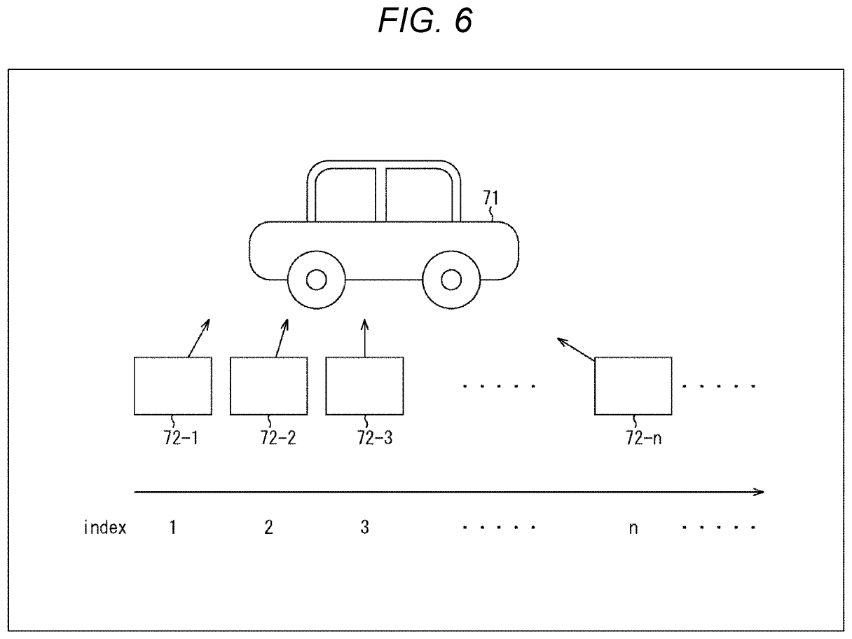

For example, the moving image may be generated by (continuous) imaging of a subject at a predetermined frame rate. That is, a so-called moving image may be generated by one imaging. For example, as illustrated in FIG. 6, by performing of moving image capturing of a subject 71 while moving the camera, a large number of captured images are generated as frame images of the moving image, such as a captured image 72-1, a captured image 72-2, a captured image 72-3, . . . , and a captured images 72-n, . . . . The moving image is easy to manage since a plurality of captured images is collected in one file (sequence). Furthermore, since these captured images are arranged in the display order as frames in the sequence of the moving image, the display order of each captured image can be easily grasped. Furthermore, since it is not necessary to perform operation of pressing a shutter button as many as the number of captured images as in the case of still images, image generation is also easy. Note that, in the moving image generated by moving image capturing in this manner, the display order and the imaging order are equivalent to each other. That is, in the case of the moving image generated by moving image capturing, the display order can be replaced with the imaging order in the description of the present specification.

Furthermore, the moving image may be generated by editing. In that case, the moving image may be, for example, a group of still images collected into one sequence. For example, a plurality of still images generated by repetition of imaging while the camera is gradually moved like a moving image may be arranged in the display order by editing and collected into one sequence as a moving image.

Furthermore, information indicating the display order may be added to the moving image. For example, as illustrated in FIG. 6, an index indicating the display order may be added to each frame. By adding such information, it is possible to more clearly indicate the display order. In a case where the information indicating the display order is added as described above, the group of images constituting the moving image do not have to be arranged in the display order. That is, the moving image also includes a group of images that can be rearranged in the display order. For example, a group of images constituting a moving image do not have to be collected in one sequence (one file). For example, the moving image may include a plurality of still images (group of images stored in files different from each other).

Note that the information indicating the display order may be any information, and may be information other than the index indicating the display order as in the example in FIG. 6. For example, in a case where the imaging order, the generation order, and the display order are equivalent to each other, information indicating an imaging time, a file name including information indicating the generation order, or the like may be used.

Furthermore, the moving image may be encoded by an encoding method for moving images (for example, advanced video coding (AVC), high efficiency video coding (HEVC), versatile video coding (VVC), or the like). In the case of the moving image, since a correlation between the frames is high, encoding efficiency can be improved by application of the encoding method for moving images, and an increase in data size of the moving image can be further suppressed. Note that, in a case where the moving image is encoded by the encoding method for moving images, the moving image obtained by decoding of a bit stream thereof is used for pose estimation and learning. Furthermore, in that case, picture order count (POC) can be used as the information indicating the display order.

### <Use of Neighboring Images>

By applying the moving image as described above, it is possible to perform pose estimation by using continuity of the moving image (relationship between images), for example. As a result, it is possible to reduce an amount of processing of the pose estimation and suppress reduction in the accuracy. Thus, it is possible to suppress reduction in the quality of the learning result (accuracy of the radiance field approximated by the neural network). Furthermore, it is possible to suppress reduction in the quality of the reconstruction of the 3D scene obtained by the inference using the learned neural network and the quality of rendering using the reconstruction.

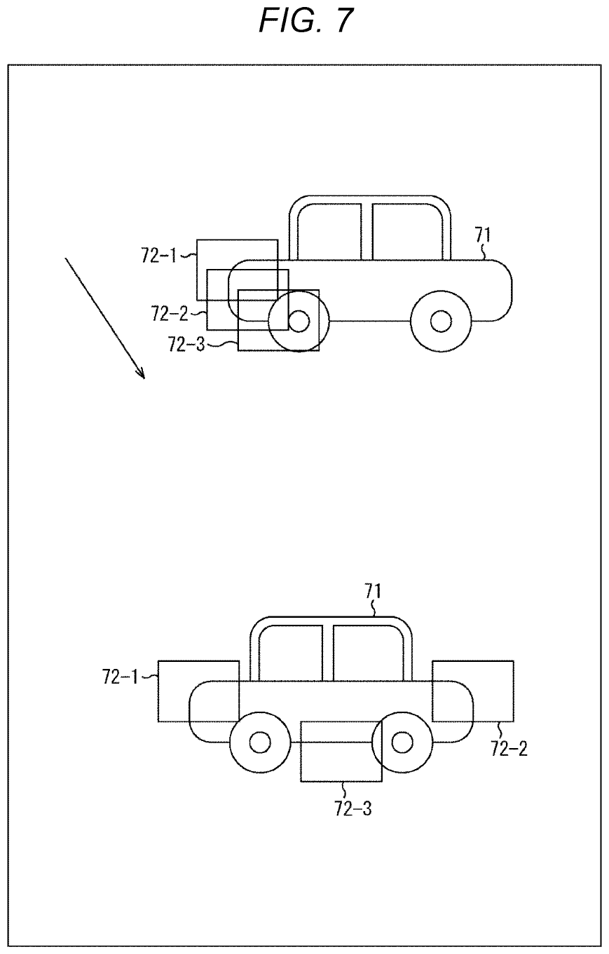

As in the example in FIG. 7, in a case where the moving image is generated by imaging of the subject 71 by so-called moving image capturing, a group of captured images that are moved little by little are generated as frame images, such as the captured image 72-1, the captured image 72-2, and the captured image 72-3 illustrated on the upper side of FIG. 7. Thus, there is a high correlation between a positional relationship between the frames and a positional relationship between the captured images. That is, if the frame rate is sufficiently high with respect to movement of the camera, the captured images of the frames in the vicinity of each other can be regarded as images captured in the vicinity of each other (also referred to as neighboring images). That is, in the case of the moving image, neighboring images can be easily specified on the basis of the frame order (arrangement order), the information indicating the display order, and the like. Furthermore, this similarly applies to a case where the moving image includes a group of still images generated by repetition of imaging while the camera is moved little by little.

On the other hand, in the case of a group of still images generated by pieces of imaging independent from each other, since a pose for the imaging is arbitrary, imaging can be performed at a random position, like the captured image 72-1, the captured image 72-2, and the captured image 72-3 illustrated on the lower side of FIG. 7, for example. For that reason, it is difficult to specify images (neighboring images) captured in the vicinity of each other. Note that, for example, even in the case of the moving image captured by moving image capturing, if the frame rate is low with respect to the movement of the camera, there is a possibility that a correlation between the frame order and the positional relationship is reduced as in the example on the lower side of FIG. 7. Furthermore, also in a case where a moving image is generated by use of a group of still images, there is a possibility that the correlation between the frame order and the positional relationship is reduced as in the example on the lower side of FIG. 7. In such a case, it may be determined whether or not the images are neighboring image on the basis of a constraint described later.

A method of using the neighboring images in the pose estimation is arbitrary. For example, the pose estimation may be performed by preferentially using the neighboring images. For example, feature point matching between neighboring images may be performed before feature point matching between other images. For example, even in the captured images at positions apart from each other that should not be matched originally, if similar feature points are accidentally present in both the images, there may be a case where the imaged are erroneously matched. In general, since a feature point correlation between the neighboring images is high, it is possible to suppress such erroneous detection of matching by prioritizing the feature point matching between the neighboring images. Thus, it is possible to suppress reduction in the accuracy of the pose estimation. Furthermore, a matching result may be weighted. That is, the matching result between the neighboring images may be weighted by a value larger than that for the matching result between other images. By doing so, since the matching result between the neighboring images is prioritized, it is possible to suppress erroneous detection of matching and to suppress reduction in the accuracy of the pose estimation.

Alternatively, the pose estimation may be performed using only the neighboring images. That is, images other than the neighboring image, which are assumed to have a low contribution to matching, may not be applied to the pose estimation. By doing so, since the number of images used for the pose estimation can be reduced, the amount of processing and a necessary memory capacity can be reduced. Furthermore, erroneous detection of matching can be suppressed, and reduction in the accuracy of the pose estimation can be suppressed. In other words, it is possible to suppress an increase in a processing load of the pose estimation while suppressing reduction in the accuracy of the pose estimation.

### <Specification of Neighboring Images>

A method of specifying the neighboring images is arbitrary. For example, as described above, the neighboring images may be specified on the basis of the frame order (display order/imaging order). For example, in a sequence in which images are arranged in the display order, neighboring images may be specified on the basis of the arrangement order. Furthermore, the neighboring images may be specified on the basis of the information indicating the display order added to the moving image.

For example, in the first information processing device, the pose estimation unit may estimate a camera pose for a target frame by using images of some consecutive frames of the moving image including the target frame for which the camera pose is estimated as neighboring images captured in the vicinity of each other. Furthermore, on the basis of display order information that is added to the moving image and indicates the display order of the frames, the pose estimation unit may set images of consecutive frames in the display order as neighboring images.

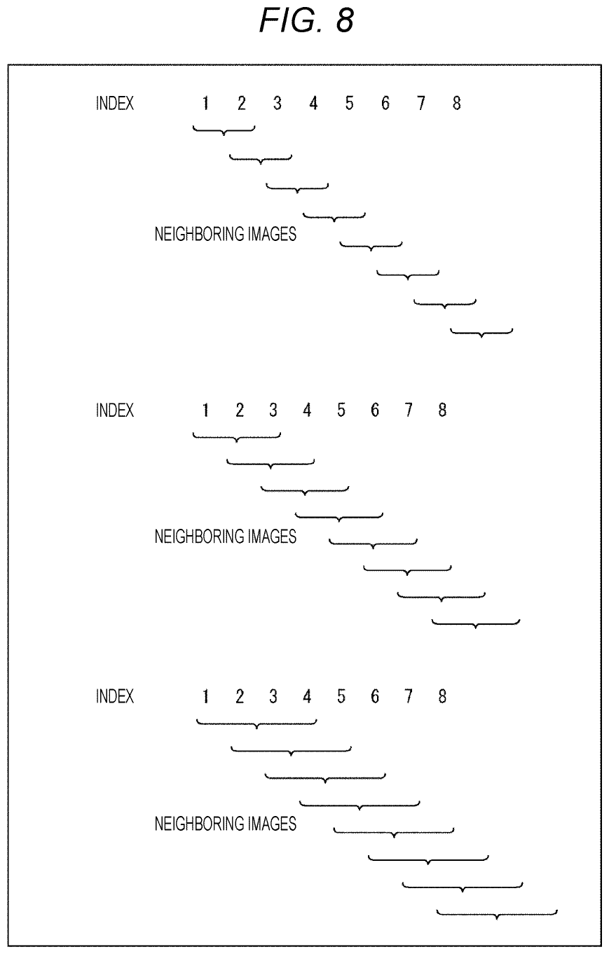

Note that the number of frames used as the neighboring images is arbitrary. For example, as illustrated in the upper part of FIG. 8, images of two consecutive frames may be set as the neighboring images. Furthermore, as illustrated in the middle part of FIG. 8, images of three consecutive frames may be set as the neighboring images. Furthermore, as illustrated in the lower part of FIG. 8, images of four consecutive frames may be set as the neighboring images. Of course, the number of frames may be five or more.

Note that information indicating the number of frames used as the neighboring images may be added to the moving image, and the neighboring images may be specified on the basis of the information. For example, in the first information processing device, the pose estimation unit may set the images of a number of the frames as the neighboring images, the number being designated by number-of-images information, on the basis of the number-of-images information that is added to the moving image and designates the number of images.

### <Constraint on Neighboring Images>

Furthermore, the neighboring images may satisfy a predetermined constraint. For example, the constraint may be satisfied among all the images of the neighboring images. Furthermore, the constraint may be satisfied between a representative image among the neighboring images and one or more other images. Note that the representative image may be, for example, an image at the center of the arrangement order of the neighboring images. Furthermore, an image having a small integer index closest to the center of the arrangement order of the neighboring images may be used as the representative image.

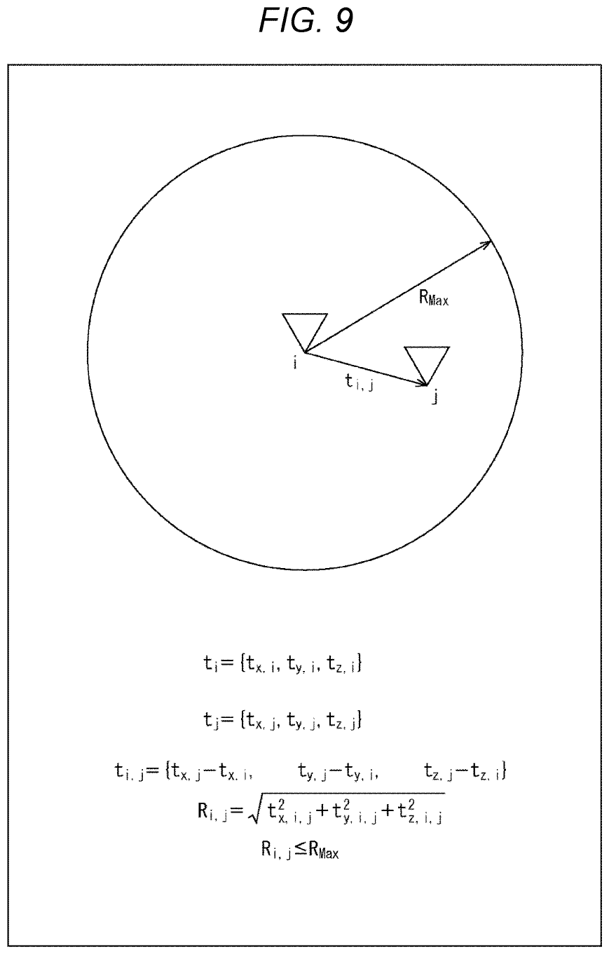

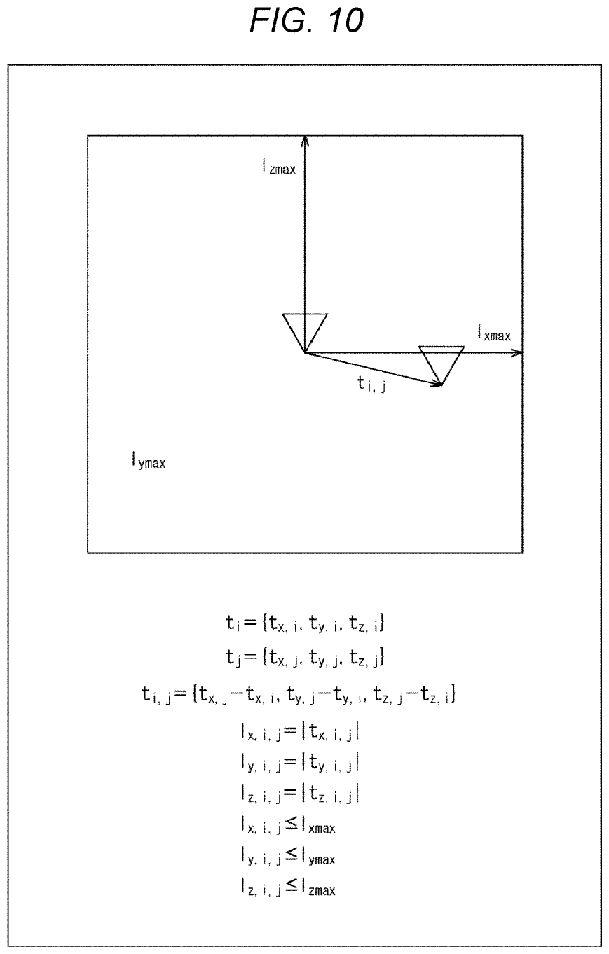

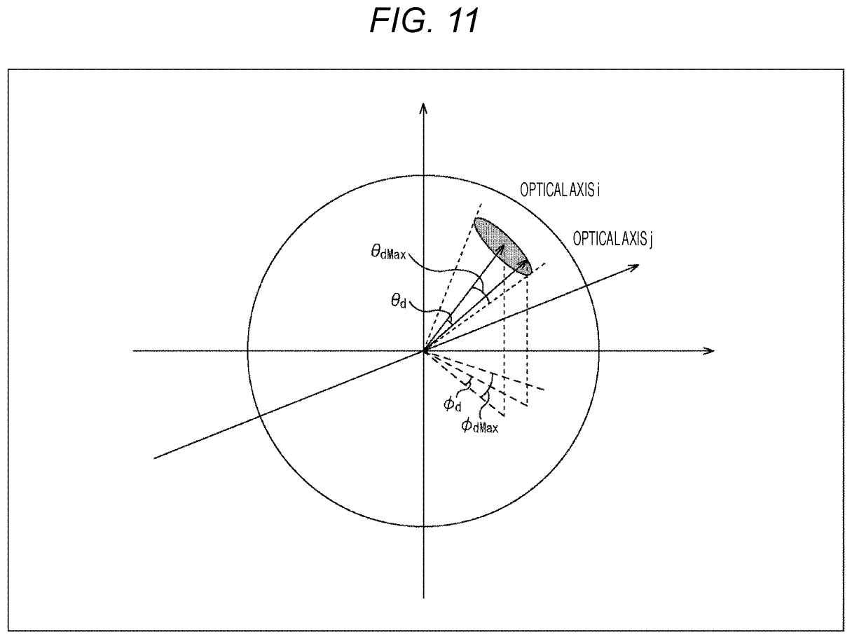

Any constraint may be satisfied by the neighboring image. For example, as illustrated in FIG. 9, an inter-image distance R_{i,j} may be less than or equal to a maximum value Rmax. In this case, matching is only required to be performed within the maximum value Rmax (spherical range). Furthermore, as illustrated in FIG. 10, inter-image distances Lx, Ly, and Lz in coordinate directions may be less than or equal to their maximum values Lxmax, Lymax, and Lzmax. In this case, matching is only required to be performed within maximum values Lmax (Lxmax, Lymax, Lzmax) (rectangular parallelepiped range). Furthermore, as illustrated in FIG. 11, inter-image posture differences (rotation angles) θd and φd may be less than or equal to their maximum values θdmax and φdmax. In this case, matching is only required to be performed within θdmax and φdmax (rotation angle range).

Note that information indicating these constraints may be added to the moving image. For example, in the first information processing device, the pose estimation unit may estimate the camera pose on the basis of constraint information that is added to the moving image and indicates a constraint between the neighboring images. For example, the constraint information may be information indicating a maximum value (for example, the maximum value Rmax, the maximum values Lmax (Lxmax, Lymax, Lzmax), and the like) of a distance between the neighboring images. Furthermore, the constraint information may be information indicating a maximum value (for example, the maximum values θdmax and φdmax, and the like) of a rotation angle between the neighboring images.

### <Learning>

Next, learning of a neural network that approximates a radiance field will be described. As described above, a moving image may be applied as input data in the learning. By receiving a moving image as an input, it is possible to more easily increase the number of viewpoints (the number of captured images). As a result, it is possible to suppress reduction in quality due to direction dependence of light as described with reference to FIG. 5. Furthermore, generation of the floater can be suppressed. Thus, it is possible to suppress reduction in quality of a learning result (neural network that approximates the radiance field). Furthermore, it is possible to suppress reduction in the quality of the reconstruction of the 3D scene obtained by the inference using the learned neural network and the quality of rendering using the reconstruction.

The moving image collected as a sequence is easy to manage. Furthermore, since an input image can be subjected to moving image encoding, a necessary memory capacity can be reduced as compared with the same number of still images. Furthermore, in the case of performing moving image encoding, it is possible to easily associate additional information by using supplemental enhancement information (SEI) as described later. Furthermore, in a case where a moving image is generated by moving image capturing, generation of the moving image is easy.

Moreover, learning may be performed using additional information added to the moving image. For example, in the first information processing device, the learning unit may further perform learning on the basis of the additional information added to the moving image. For example, information regarding imaging or the imaging unit is added to the moving image as the additional information, whereby the learning unit can grasp an imaging condition or the like of each captured image on the basis of the additional information, and can reflect the information in learning. As a result, it is possible to suppress reduction in the quality of the learning result. Furthermore, it is possible to suppress reduction in the quality of the reconstruction of the 3D scene obtained by the inference using the learned neural network and the quality of rendering using the reconstruction.

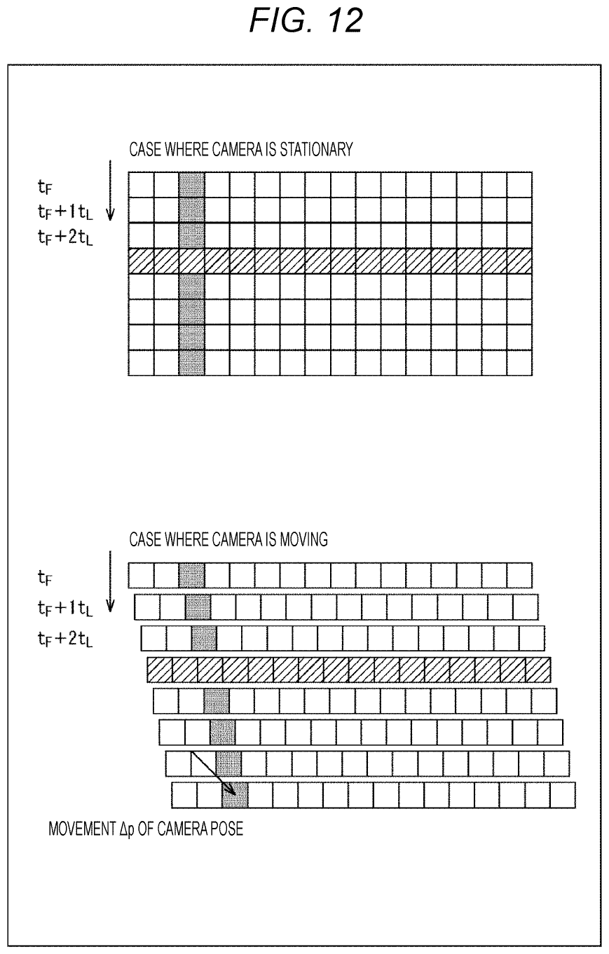

The additional information may include, for example, information regarding a rolling shutter of the imaging unit that has generated the moving image. An example of a state of the rolling shutter is illustrated in FIG. 12. The image sensor converts light into an electrical signal. In order to reduce costs, energy received in a line is often converted into a digital signal. A start time of imaging of the first line of a current frame is represented as t_F. An imaging time of one line is represented as t_L. Thus, after the second line, imaging is started with a delay at t_F+it_L. Here, i indicates a row number of the image sensor. In a case where the camera is moving, a light receiving position of actually captured light moves as in the example at the lower part of FIG. 12. This phenomenon is a phenomenon called “focal plane shutter distortion” or “rolling shutter distortion”. When an origin and a direction of a light beam used in the NeRF learning is calculated, influence of the rolling shutter is considered, whereby a more accurate 3D reconstruction is implemented. Information on a phase of the rolling shutter is included in auxiliary information on the moving image. If an amount of movement Ap of the camera pose and the information on the phase of the rolling shutter are known, an actual light receiving position of the light beam is known. Since the information on the phase of the rolling shutter comes from a system of the camera, it is easier to know the information on an encoder side than on a decoder side. Such information is used, whereby accuracy of a posture of the light beam can be improved, and reduction in the quality of the learning result can be suppressed. Furthermore, it is possible to suppress reduction in the quality of the reconstruction of the 3D scene obtained by the inference using the learned neural network and the quality of rendering using the reconstruction.

Furthermore, the additional information may include, for example, information indicating a shutter system of the imaging unit that has generated the moving image. For example, information indicating whether the shutter is a global shutter or a rolling shutter may be included in the additional information. In the case of the global shutter, since “focal plane shutter distortion” does not occur, the origin and direction of the light beam can be known with high accuracy by use for the NeRF learning even in a case where the movement of the camera pose is large. On the other hand, in the case of the rolling shutter, when the movement of the camera pose is fast, focal plane shutter distortion occurs, and an error occurs in the origin and direction of the light beam. Thus, a condition that the rolling shutter is used and the movement of the camera pose is fast, that is, an image in which focal plane shutter distortion is concerned is not selectively used for the NeRF learning, so that only an image with high reliability and little focal plane shutter distortion can be used for the NeRF learning. Quality of the 3D reconstruction can be improved and rendered image quality can be improved. Note that information indicating whether the direction is the vertical direction or the horizontal direction of the line of the rolling shutter may be included in the additional information. If it is known whether the direction of the line of the shutter of the rolling shutter is vertical or horizontal, it is known how focal plane shutter distortion occurs, so that it is possible to perform compensation.

Furthermore, the additional information may include structure information regarding structure of the imaging unit that has generated the moving image. The structure information may include, for example, information indicating a model of a parameter of the imaging unit. In the case of a pinhole camera, 3D points correspond to image points as described in the previous slide. However, since an actual camera has lens distortion due to a lens, it is necessary to correct the origin and direction of the light beam. It is possible to assume several representative camera models for the lens distortion. Examples of types and coefficients of the camera model will be described below.
Example of COLMAP software (https://colmap.github.io/cameras.html, https://github.com/colmap/colmap/blob/3.7/src/base/camera models.h)
Simple Pinhole camera model: f, cx, cy
Pinhole camera model: fx, fy, cx, cy
Simple camera model with one focal length and one radial distortion parameter: f, cx, cy, k
Simple camera model with one focal length and two radial distortion parameters: f, cx, cy, k1, k2
OpenCV camera model: fx, fy, cx, cy, k1, k2, p1, p2
OpenCV fish-eye camera model: fx, fy, cx, cy, k1, k2, k3, k4
Full OpenCV camera model: fx, fy, cx, cy, k1, k2, p1, p2, k3, k4, k5, k6
FOV camera model: fx, fy, cx, cy, omega
Simple camera model with one focal length and one radial distortion parameter, suitable for fish-eye cameras: f, cx, cy, k
Simple camera model with one focal length and two radial distortion parameters, suitable for fish-eye cameras: f, cx, cy, k1, k2
Camera model with radial and tangential distortion coefficients and additional coefficients accounting for thin-prism distortion: fx, fy, cx, cy, k1, k2, p1, p2, k3, k4, sx1, sy1

Since the camera model is information related to structure of the camera, it is possible to know the information more easily on the encoder side close to the camera, but it is difficult to know the information on the decoder side. By knowing the camera model, it is possible to improve processing speed of the estimation of the camera pose, and increase robustness and accuracy. By consideration of the lens distortion, the origin and direction of the light beam are correctly corrected, so that the quality of the 3D reconstruction can be improved, and the quality of the rendered image can be improved.

Furthermore, the structure information may include information indicating internal parameters of the imaging unit. The camera internal parameters have been given as the examples of the camera model. Included are a focal point distance f, a principal point c, radial distortion coefficients k, tangential distortion coefficients p, and the like. If the camera internal parameters themselves are obtained in addition to the camera model, a processing time for estimation on the decoder side can be reduced, the accuracy of the estimation of the camera pose and the accuracy of the 3D reconstruction are improved, and the quality of the rendered image is improved. Since there are many unknown variables when trying to estimate camera parameters, there is a concern that calculation becomes unstable and estimation fails, or accuracy decreases. In particular, when a complicated camera model is used, the number of camera parameters increases. Since the camera parameters are determined by the structure of the camera, the camera parameters can be more easily known on the encoder side close to the camera.

Furthermore, the structure information may include information indicating errors of the internal parameters. A technology has been proposed for adjusting the camera parameters in the NeRF learning (for example, NeRF—(Neural Radiance Fields Without Known Camera Parameters)). By knowing the errors of the camera internal parameters, it is possible to adjust amounts of adjustment of the camera internal parameters during the NeRF learning. For example, if the errors of the camera internal parameters are known to be 5%, the adjustment of the camera internal parameters performed at the time of the NeRF learning can be processed within a range of 5%. By designating a range of the errors, it is possible to prevent the adjustment of the camera internal parameters from becoming unstable. Since the errors of the camera internal parameters can be known from a camera internal parameters estimation method adopted on the encoder side or the structure of the camera, it is more desirable to transmit the additional information from the encoder side than from the decoder side.

Furthermore, the structure information may include identification information (camera ID) on the imaging unit. The camera ID is a number for knowing which camera is used when capturing is performed by a plurality of cameras. When moving images of a plurality of viewpoints are captured at a time by use of equipment such as a camera array, moving images of a plurality of cameras are sent. The decoder reads the camera ID and finds the same camera ID as that for a past moving image, thereby being able to know that the same camera as that for the past moving image is used. The same camera can utilize the fact that characteristics and positions of the cameras are the same. For example, when an image is used for the NeRF learning, it is known that the positions of the cameras having the same camera ID are the same, and it is not necessary to estimate the camera pose. Furthermore, by knowing that the internal parameters such as the lens distortion of the cameras are the same, it is easy to estimate the camera pose.

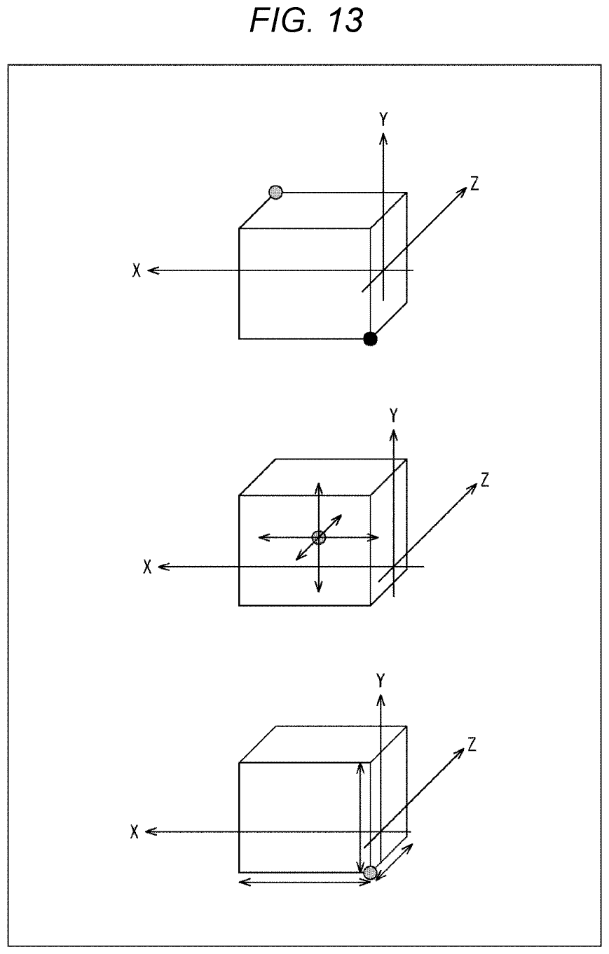

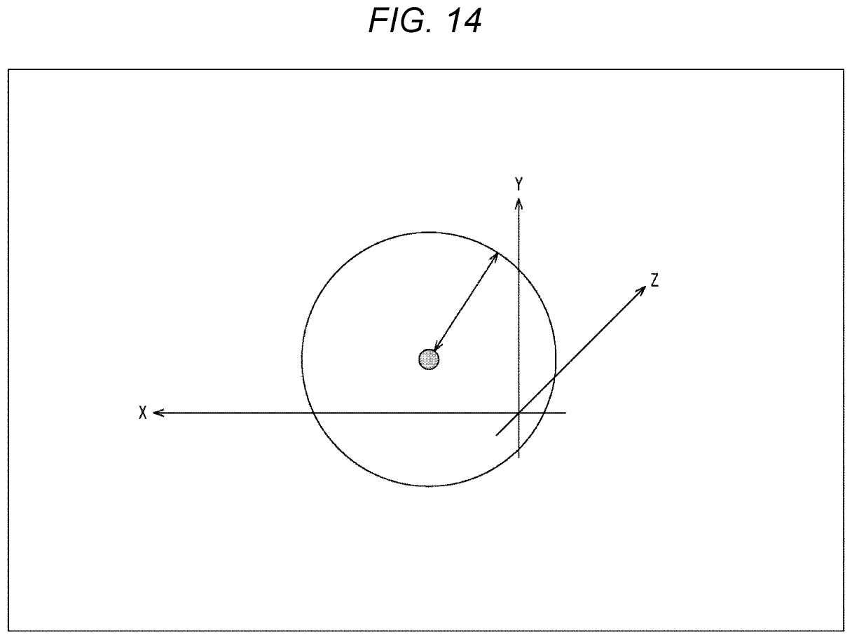

Furthermore, the additional information may include motion information regarding motion of the imaging unit that has generated the moving image. For example, the motion information may include information regarding a range of the pose of the imaging unit (range of the camera pose). In a case where a moving image used for learning is obtained by streaming, since a future camera pose is unknown, it is necessary to wait without starting the NeRF learning. The range of the camera pose is known in advance, whereby a linear region of the 3D reconstruction of the NeRF learning can be known quickly, the learning can be started even if all the learning data are not prepared, and a delay until completion of the learning can be reduced. For example, as illustrated in FIG. 13, an Axis-Aligned Bounding Box (AABB) may be set, and information of the AABB may be included in the motion information. For example, a box-shaped range is set along the coordinate axes X, Y, and Z. As in the example illustrated in the upper part of FIG. 13, coordinates are set of a point (gray point) having a maximum value along the X, Y, and Z axes, and of a point (black point) having a minimum value. Within the minimum value and the maximum value is a movement range of the camera pose. Furthermore, as in the example illustrated in the middle part of FIG. 13, a position of the center, and widths indicated in parallel with the X, Y, and Z axes may be set. Furthermore, as in the example illustrated in the lower part of FIG. 13, distances between the point of the minimum value and the maximum value may be set. Eight vertices of the box are set. Compared with the AABB, the range can be set in a more flexible shape. Furthermore, as in the example illustrated in FIG. 14, a range may be set on a sphere. The range can be set by coordinates of the center and radius of the sphere.

Furthermore, the motion information may include information indicating an error of the pose of the imaging unit (error of the camera pose). A technology has been proposed for adjusting the camera pose in the NeRF learning (for example, bundle-adjusting neural radiance fields (BARF)). By knowing the error of the camera pose, it is possible to adjust an amount of adjustment of the camera pose during the NeRF learning. For example, if the error of the camera pose is known to be 5%, the adjustment of the camera pose performed at the time of the NeRF learning can be processed within a range of 5%. By designating a range of the error, it is possible to prevent the adjustment of the camera pose from becoming unstable. Since the error of the camera pose can be known from a camera pose estimation method adopted on the encoder side or a sensor such as an inertial measurement unit (IMU), it is more desirable to transmit the additional information from the encoder side than from the decoder side.

Furthermore, the motion information may include information indicating acceleration of the imaging unit. A camera equipped with an inertial measurement unit (IMU) can easily know the acceleration. For example, even if an image and an SfM algorithm are used, it is difficult to estimate the camera pose under the following conditions.
An image without texture such as a white or black wall
A required feature amount cannot be obtained by the SfM.
In a case where a subject of a captured image moves, an error occurs because the SfM algorithm assumes a stationary object.

With the information of the acceleration of the camera, the accuracy of the estimation of the camera pose is improved and the robustness is improved. In a case where the information of the acceleration and the movement of the camera pose obtained by the SfM do not match, the accuracy of the camera pose is suspected, so that it is also possible to use the information for control not used for the NeRF learning.

Furthermore, the additional information may include imaging information regarding imaging for generating a moving image. For example, the imaging information may include information indicating a setting of a shutter speed in the imaging. By knowing the shutter speed, it is possible to easily predict an amount of camera motion blur. There are, for example, the following research papers for compensating blurring of an input image.
BAD-NeRF: Bundle Adjusted Deblur Neural Radiance Fields
Deblur-NeRF: Neural Radiance Fields from Blurry Images

Since the shutter speed is determined by the setting of the camera, it is easier to know the shutter speed on the encoder side than on the decoder side. If a change in the camera pose and the shutter speed are known, the motion blur captured by the image sensor can be predicted, and by performing the NeRF learning to compensate for the motion blur, it is possible to improve the accuracy of the 3D reconstruction, and the quality of the rendered image is improved.

Furthermore, the imaging information may include information indicating a setting of ISO sensitivity in the imaging. The ISO sensitivity of a digital camera is a reference value for amplifying a signal in an image sensor developed by the International Organization for Standardization (ISO) ISO 12232 (see, for example, ISO 12232:2019 (en) Photography—Digital still cameras—Determination of exposure index, ISO speed ratings, standard output sensitivity, and recommended exposure index). When the value is large, an amplification degree of the signal of the image sensor increases, and a bright image is obtained. On the other hand, it is known that an image with much noise is obtained due to amplification. In the original paper of NeRF [1] and the like, it is not considered that brightness of an image changes due to the ISO sensitivity or the like. The ISO sensitivity is obtained as the auxiliary information, whereby it can be seen that the information is read and the brightness of the image has changed. The decoder recognizes that the brightness has changed, whereby the quality of the rendered image can be improved by use of, for example, appearance embedding of Non-Patent Document 3. Since the ISO sensitivity is a parameter determined by control of the camera, it is easier to know the ISO sensitivity on the encoder side than on the decoder side.

Furthermore, the imaging information may include an aperture value in the imaging. The camera has a mechanism for changing an amount of incoming light, and the amount is referred to as an f-number (aperture value). When the f-number decreases, more light is captured to form a bright image, and conversely, when the f-number decreases, less light is captured to form a dark image. Furthermore, a change in an area through which light passes affects the blur of the image, and the image blurs as the f-number decreases, and the blur becomes less as the f-number increases. Since the f-number is a parameter determined by control of the camera, it is easier to know the f-number on the encoder side than on the decoder side. For example, the quality of the rendered image can be improved by use of the appearance embedding of Non-Patent Document 3.

Furthermore, the imaging information may include information regarding color temperature of the moving image or information indicating a white balance adjustment value in the imaging. Even a white subject looks different in color depending on a color of a light source that illuminates the subject. Redness is strong when illuminated with an incandescent lamp, and blueness is strong in shade when the weather is good. This color tone is called white balance. A digital camera has a function of adjusting white balance, and designation is often performed with color temperature. Since the information is a parameter determined by control of the camera, it is easier to know the parameter on the encoder side than on the decoder side. For example, the quality of the rendered image can be improved by use of the appearance embedding of Non-Patent Document 3.

Furthermore, the imaging information may include information indicating an imaging time at which the imaging is performed. A device such as a camera array can simultaneously capture moving images from a plurality of viewpoints. However, if a capturing time of an image is unknown, it is not possible to designate the time of the image in the NeRF learning. If information indicating a capturing time of a moving image is added as the auxiliary information, learning data can be used together with the time in the NeRF learning. Furthermore, time information can be used to consider a time of an input image in the NeRF learning considering time of Non-Patent Document 5 or the like.

### <Transmission of Additional Information (SEI)>

The above-described additional information may be transmitted by being added to (a bit stream of) a moving image. For example, a second information processing device may include: an imaging unit that images an object to generate a moving image; an additional information generation unit that generates additional information to be used for any one or both of estimation of a camera pose for each of frames of the moving image, and learning of a neural network that approximates a radiance field expressing a scene in a space including the object by a color in each of directions at each of positions in the space and opacity at each position in the space, to add the additional information to the moving image; and an encoding unit that encodes the moving image to which the additional information is added to generate a bit stream. For example, in the second information processing method, processing may be performed of: imaging an object to generate a moving image; generating additional information to be used for any one or both of estimation of a camera pose for each of frames of the moving image, and learning of a neural network that approximates a radiance field expressing a scene in a space including the object by a color in each of directions at each of positions in the space and opacity at each position in the space, to add the additional information to the moving image; and encoding the moving image to which the additional information is added to generate a bit stream.

For example, in the second information processing device, the encoding unit may store the additional information in supplemental enhancement information (SEI) of the bit stream.

As described above, the additional information may include, for example, information regarding the rolling shutter of the imaging unit. Furthermore, the additional information may include information indicating the shutter system of the imaging unit.

Furthermore, the additional information may include structure information regarding the structure of the imaging unit. For example, the structure information may include information indicating the model of the parameter of the imaging unit. Furthermore, the structure information may include information indicating internal parameters of the imaging unit. Furthermore, the structure information may include information indicating errors of the internal parameters. Furthermore, the structure information may include identification information on the imaging unit.

Furthermore, the additional information may include motion information regarding motion of the imaging unit. The motion information may include information regarding a range of the pose of the imaging unit. Furthermore, the motion information may include information indicating an error of the pose of the imaging unit. Furthermore, the motion information may include information indicating acceleration of the imaging unit.

Furthermore, the additional information may include imaging information regarding imaging of the object. For example, the imaging information may include information indicating a setting of the shutter speed in the imaging. Furthermore, the imaging information may include information indicating a setting of the ISO sensitivity in the imaging. Furthermore, the imaging information may include information indicating an aperture value in the imaging. Furthermore, the imaging information may include information regarding color temperature of the moving image or information indicating a white balance adjustment value in the imaging. Furthermore, the imaging information may include information indicating an imaging time at which the imaging is performed.

Known information is added to information of a moving image as additional information and transmitted by a video camera. The structure of the camera and the characteristics of the equipped lens are known, and the camera model, camera internal parameters, and the shutter system are known. Since the system of the video camera sets the shutter speed of the camera, the phase of the rolling shutter, the ISO sensitivity, the f-number (aperture value), and the color temperature/white balance, these are pieces of known information. The video camera is designed so that the camera ID can be set, and a user sets the camera ID, whereby known information is obtained. The video camera is designed to have highly accurate time information, whereby known information is obtained. Design is performed so that a movement range of the video camera can be set, and the user sets the movement range, whereby known information is obtained. Design is performed so that the pose of the camera can be estimated by use of the visual SLAM algorithm at the time of imaging, whereby known information is obtained. At this time, the error of the camera pose is known information from the accuracy of the used visual SLAM algorithm.

Since the encoder knows in advance that the NeRF learning can be performed well due to presence of the additional information, encoding is performed with a high compression ratio to reduce a transmission data size even if encoding distortion is slightly large, and a cost required for transmission such as a communication fee can be reduced.

The decoder decodes the transmitted moving image and reads the additional information at the same time. The additional information is obtained on the decoder side. By performing the NeRF learning using such additional information, it is possible to improve the quality of the 3D reconstruction and the quality of the rendered image. Furthermore, the robustness of the estimation of the camera pose and the camera internal parameters is improved, and the processing time can be reduced.

### 4. First Embodiment

### <Information Processing System>

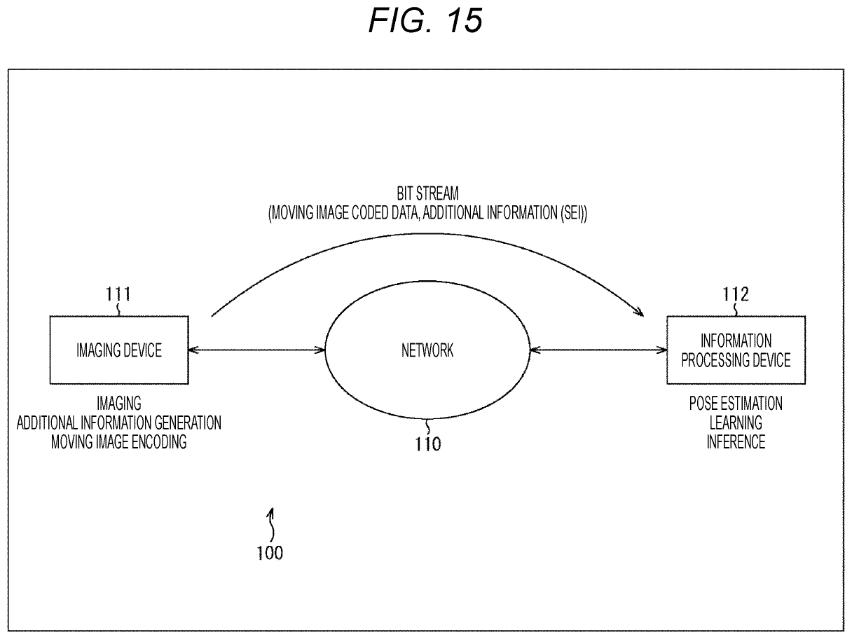

FIG. 15 is a block diagram illustrating a main configuration example of an information processing system to which the present technology described above in <3. NeRF learning using moving image> is applied. An information processing system 100 illustrated in FIG. 15 is a system that images an object to generate a captured image, performs NeRF learning using the captured image, and generates a neural network that approximates a radiance field corresponding to the object. Furthermore, inference is performed using the learned neural network.

As illustrated in FIG. 15, the information processing system 100 includes an imaging device 111 and an information processing device 112. The imaging device 111 and the information processing device 112 are communicably connected to each other via a network 110. The imaging device 111 can function as the second information processing device described above in <3. NeRF learning using moving image>. For example, the imaging device 111 performs processing such as imaging of an object, generation of additional information to be added to a moving image, and encoding of the moving image to which the additional information is added. Furthermore, the imaging device 111 can transmit a bit stream including moving image coded data obtained by encoding of the moving image and the additional information to the information processing device 112 via the network 110.

The information processing device 112 performs processing related to the NeRF learning. The information processing device 112 can function as the first information processing device described above in <3. NeRF learning using moving image>. For example, the information processing device 112 can receive and decode the bit stream transmitted from the imaging device 111 to generate (restore) the moving image and the additional information. Furthermore, the information processing device 112 can perform pose estimation and learning by using the moving image. Furthermore, the information processing device 112 can perform the pose estimation and the learning by further using the additional information. Furthermore, the information processing device 112 can perform inference (rendering) using the neural network learned as described above.

### <Imaging Device>

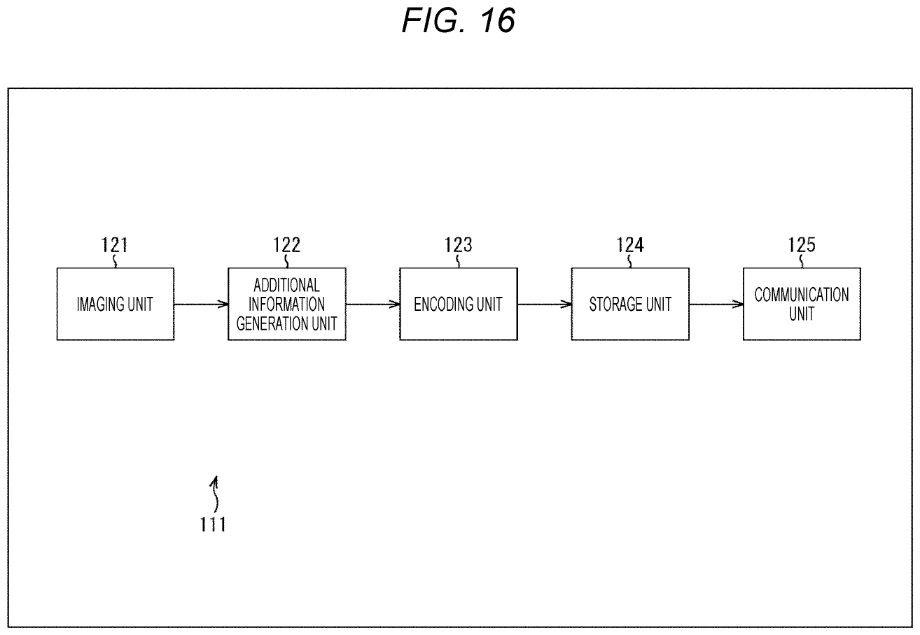

FIG. 16 is a block diagram illustrating a main configuration example of the imaging device 111. As illustrated in FIG. 16, the imaging device 111 includes an imaging unit 121, an additional information generation unit 122, an encoding unit 123, a storage unit 124, and a communication unit 125.

The imaging unit 121 images a subject such as an object and generates a captured image. For example, the imaging unit 121 performs moving image capturing and generates a moving image. The imaging unit 121 supplies the generated moving image to the additional information generation unit 122. The additional information generation unit 122 generates additional information to be added to the moving image. The additional information is used for one or both of estimation of a camera pose and learning of a neural network that approximates a radiance field. The additional information generation unit 122 supplies the moving image and the additional information to the encoding unit 123. The encoding unit 123 encodes the moving image by an encoding method for moving images, and generates a bit stream including moving image coded data. Furthermore, the encoding unit 123 stores the additional information in SEI of the bit stream. The encoding unit 123 supplies the bit stream to the storage unit 124.

The storage unit 124 stores the bit stream. In a case where a predetermined condition is satisfied at a predetermined timing, or on the basis of a request from the communication unit 125 or the like, the storage unit 124 reads the bit stream and supplies the read bit stream to the communication unit 125.

The communication unit 125 transmits the bit stream to the information processing device 112 via the network 110.

The present technology described above in <3. NeRF learning using moving image> can be applied to the imaging device 111. That is, as described above, the imaging device 111 can function as the second information processing device described above in <3. NeRF learning using moving image>. For example, the imaging unit 121 of the imaging device 111 may image an object and generate a moving image. Furthermore, the additional information generation unit 122 may generate additional information to be used for any one or both of estimation of a camera pose for each frame of the moving image and learning of a neural network that approximates a radiance field expressing a scene in a space including an object by a color in each direction at each position in the space and opacity of each position in the space, and add the additional information to the moving image. Furthermore, the encoding unit 123 may encode the moving image to which the additional information is added to generate a bit stream. Thus, the imaging device 111 can suppress reduction in the quality of the learning result of the neural network that approximates the radiance field by the information processing device 112. Furthermore, it is possible to suppress reduction in the quality of the reconstruction of the 3D scene obtained by the inference using the learned neural network and the quality of rendering using the reconstruction.

### <Information Processing Device>

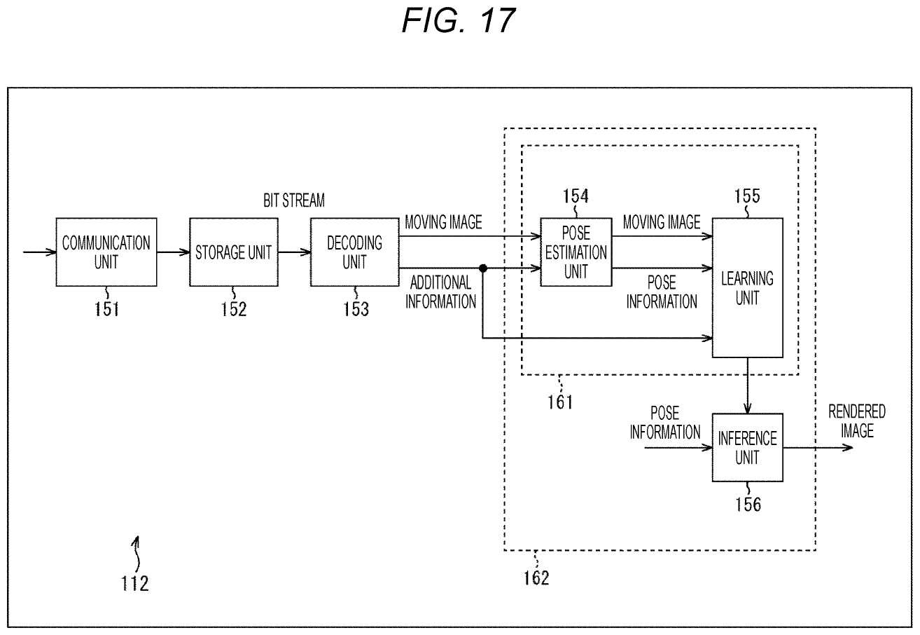

FIG. 17 is a block diagram illustrating a main configuration example of the information processing device 112. As illustrated in FIG. 17, the information processing device 12 includes a communication unit 151, a storage unit 152, a decoding unit 153, a pose estimation unit 154, a learning unit 155, and an inference unit 156.

The communication unit 151 receives the bit stream transmitted from the imaging device 111 and supplies the bit stream to the storage unit 152. The storage unit 152 stores the bit stream. Furthermore, in a case where a predetermined condition is satisfied at a predetermined timing, or on the basis of a request from the communication unit 125 or the like, the storage unit 152 reads the bit stream and supplies the read bit stream to the decoding unit 153.

The decoding unit 153 decodes the bit stream, and generates (restores) the moving image and the additional information. The decoding unit 153 supplies the moving image to the pose estimation unit 154. Furthermore, the decoding unit 153 supplies the additional information to the pose estimation unit 154 and the learning unit 155.

The pose estimation unit 154 estimates a camera pose for each captured image (frame image of the moving image) by using the supplied moving image. Furthermore, the pose estimation unit 154 may perform the pose estimation further on the basis of the additional information. The pose estimation unit 154 supplies the moving image and the estimated pose information of the camera pose to the learning unit 155.

The learning unit 155 uses the moving image and the pose information to perform learning of a neural network that approximates a radiance field. Furthermore, the learning unit 155 may perform the learning further on the basis of the additional information. The learning unit 155 supplies a learning result (a parameter indicating the learned neural network) to the inference unit 156.

The inference unit 156 constructs the learned neural network by acquiring and setting the parameter. Then, the inference unit 156 performs rendering using the learned neural network, and generates and outputs a rendered image corresponding to an input of the pose information on a desired viewpoint.

The present technology described above in <3. NeRF learning using moving image> can be applied to the information processing device 112. That is, as described above, the information processing device 112 can function as the first information processing device described above in <3. NeRF learning using moving image>. For example, the pose estimation unit 154 of the information processing device 112 may estimate a camera pose for each frame of a moving image obtained by imaging of an object. The pose estimation unit 154 may further estimate camera internal parameters. Furthermore, using the moving image and the estimated camera pose, the learning unit 155 may perform learning of a neural network that approximates a radiance field expressing a scene in a space including an object by a color in each direction at each position in the space and opacity at each position in the space. Furthermore, the pose estimation unit may estimate the camera pose for a target frame by using images of some consecutive frames of the moving image including the target frame for which the camera pose is estimated as neighboring images captured in the vicinity of each other. Thus, the information processing device 112 can suppress reduction in the quality of the learning result of the neural network that approximates the radiance field. Furthermore, it is possible to suppress reduction in the quality of the reconstruction of the 3D scene obtained by the inference using the learned neural network and the quality of rendering using the reconstruction.

Note that, as indicated by a dotted line 161, the pose estimation unit 154 and the learning unit 155 may be used as one information processing device (first information processing device). Furthermore, as indicated by a dotted line 162, the pose estimation unit 154, the learning unit 155, and the inference unit 156 may be used as one information processing device (first information processing device).

### <Flow of Imaging Processing>

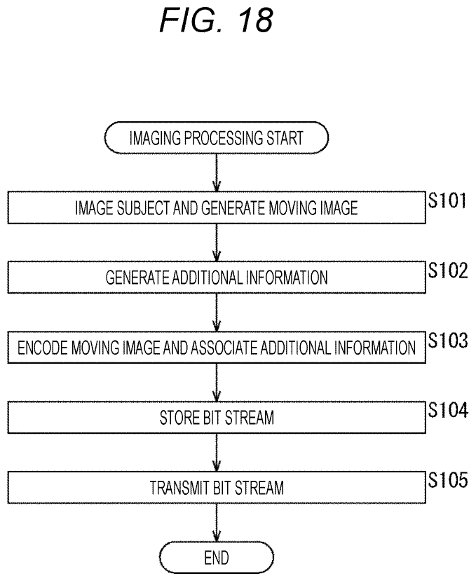

An example of a flow of imaging processing executed by the imaging device 111 will be described with reference to a flowchart of FIG. 18.

When the imaging processing is started, the imaging unit 121 images a subject and generates a moving image in step S101.

In step S102, the additional information generation unit 122 generates additional information to be added to the moving image.

In step S103, the encoding unit 123 encodes the moving image and associates the additional information. For example, the encoding unit 123 stores the additional information in SEI, and generates a bit stream including moving image coded data obtained by encoding of the moving image and the additional information.

In step S104, the storage unit 124 stores the bit stream.

In step S105, the communication unit reads the bit stream and transmits the bit stream to the information processing device 112 via the network 110.

When the processing of step S105 ends, the imaging processing ends.

By executing each of pieces of processing in this manner, the imaging device 111 can suppress reduction in the quality of the learning result of the neural network that approximates the radiance field by the information processing device 112. Furthermore, it is possible to suppress reduction in the quality of the reconstruction of the 3D scene obtained by the inference using the learned neural network and the quality of rendering using the reconstruction.

### <Flow of Learning Processing>

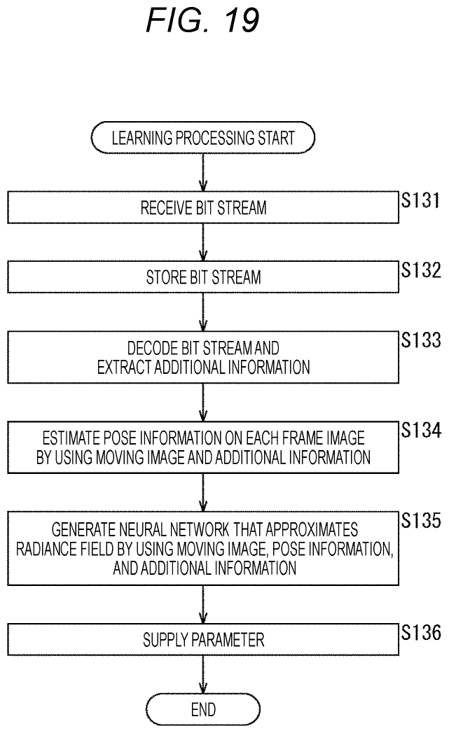

An example of a flow of learning processing executed by the information processing device 112 will be described with reference to a flowchart of FIG. 19.

When the learning processing is started, the communication unit 151 receives the bit stream transmitted from the imaging device 111 in step S131. In step S132, the storage unit 152 stores the bit stream.

In step S133, the decoding unit 153 reads and decodes the bit stream to generate (restore) the moving image. Furthermore, the decoding unit 153 extracts the additional information stored in the SEI.

In step S134, the pose estimation unit 154 estimates a camera pose for each frame image by using the moving image and the additional information. Note that the pose estimation unit 154 may further estimate camera internal parameters.

In step S135, the learning unit 155 performs learning using the moving image, the estimated pose information, and the additional information, and generates a neural network that approximates a radiance field.

In step S136, the learning unit 155 supplies a parameter indicating a learning result to the inference unit 156. When the processing of step S136 ends, the learning processing ends.

By executing each of pieces of processing in this manner, the information processing device 112 can suppress reduction in the quality of the learning result of the neural network that approximates the radiance field.

### <Flow of Pose Estimation Processing>

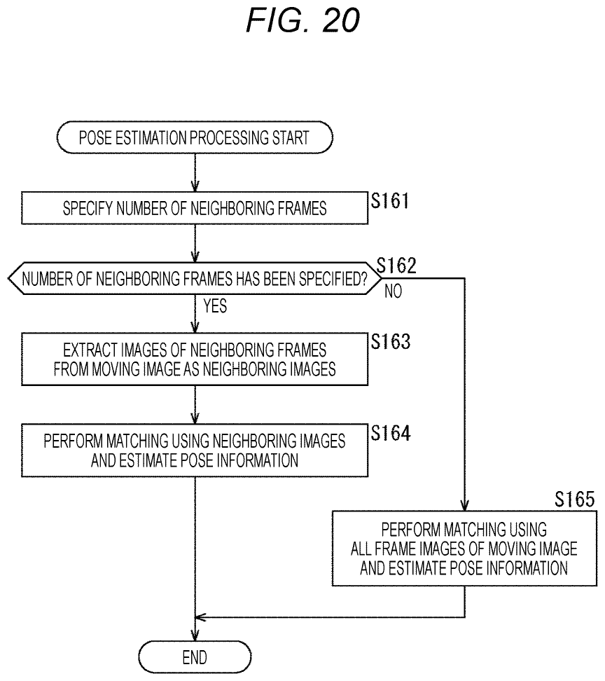

Note that it may be enabled to perform pose estimation using only neighboring images. An example of a flow of pose estimation processing in that case will be described with reference to a flowchart of FIG. 20.

When the pose estimation processing is started, in step S161, the pose estimation unit 154 specifies the number of neighboring frames on the basis of the additional information, for example.

In step S162, the pose estimation unit 154 determines whether or not the number of neighboring frames has been specified. In a case where it is determined that the number of neighboring frames has been specified, the processing proceeds to step S163.

In step S163, the pose estimation unit 154 extracts images of the neighboring frames from the moving image as neighboring images.

In step S164, the pose estimation unit 154 performs feature point matching using the neighboring images, and estimates pose information on the basis of a result of the matching. When the processing of step S164 ends, the pose estimation processing ends.

Furthermore, in a case where it is determined in step S162 that the number of neighboring frames has not been specified, the processing proceeds to step S165.

In step S165, the pose estimation unit 154 performs feature point matching using all frame images of the moving image, and estimates pose information on the basis of a result of the matching. When the processing of step S165 ends, the pose estimation processing ends.

By executing each of pieces of processing in this manner, the information processing device 112 can execute the pose estimation processing using only the neighboring images, and can suppress an increase in a load of the pose estimation processing. Furthermore, it is possible to suppress reduction in accuracy of the pose information.

### <Flow of Inference Processing>

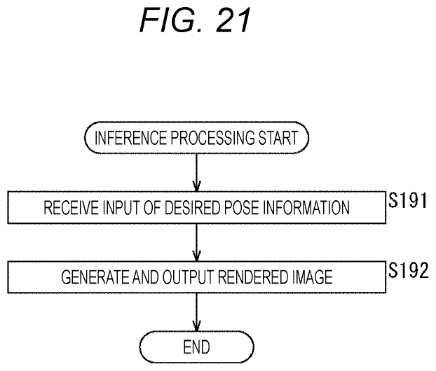

An example of a flow of inference processing executed by the information processing device 112 in a case where rendering is performed using the above-described learning result will be described with reference to a flowchart of FIG. 21.

When the inference processing is started, the inference unit 156 receives an input of desired pose information in step S191. In step S192, the inference unit 156 generates and outputs a rendered image corresponding to the pose information. When the processing of step S192 ends, the inference processing ends.

By executing each of pieces of processing as described above, the information processing device 112 can suppress reduction in the quality of the reconstruction of the 3D scene and the quality of rendering using the reconstruction.

### 5. Second Embodiment

### <Imaging Device>

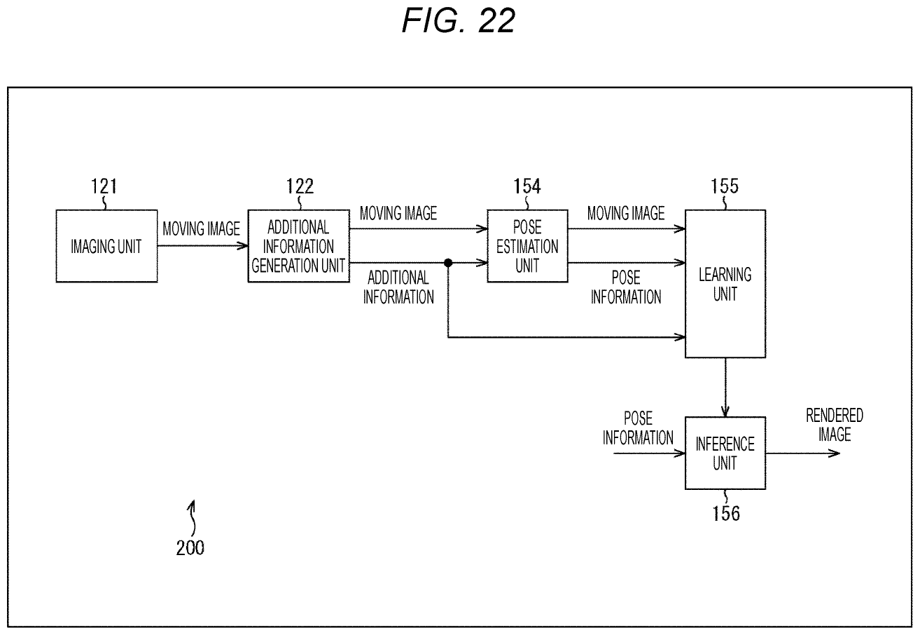

Note that the NeRF learning and the inference may be performed in the imaging device. FIG. 22 is a block diagram illustrating a main configuration example of an imaging device 200 in that case. As illustrated in FIG. 22, the imaging device 200 includes the imaging unit 121, the additional information generation unit 122, the pose estimation unit 154, the learning unit 155, and the inference unit 156. Each processing unit executes processing similar to the case of the first embodiment.

That is, the imaging device 200 images an object to generate a moving image, generates additional information to be added to the moving image, and performs pose estimation and learning by using the moving image and the additional information. Furthermore, the imaging device 200 performs inference (rendering) using a result of the learning. Thus, similarly to the case of the information processing device 112, the present technology described above in <3. NeRF learning using moving image> can be applied to the imaging device 200.

With such a configuration, the imaging device 200 can suppress reduction in the quality of the learning result of the neural network that approximates the radiance field. Furthermore, it is possible to suppress reduction in the quality of the reconstruction of the 3D scene obtained by the inference using the learned neural network and the quality of rendering using the reconstruction.

### <Flow of Imaging Learning Processing>

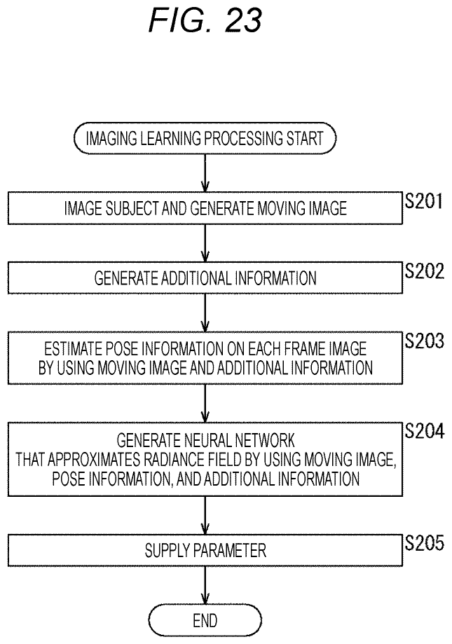

An example of a flow of imaging learning processing executed by the imaging device 200 will be described with reference to a flowchart of FIG. 23.

Pieces of processing of steps S201 and S202 are performed similarly to pieces of processing of steps S101 and S102 (FIG. 18).

Pieces of processing of steps S203 to S205 are executed similarly to pieces of processing of steps S134 to S136 (FIG. 19).

By executing each pieces of processing in this manner, the imaging device 200 can suppress reduction in the quality of the learning result of the neural network that approximates the radiance field.

Note that the inference processing is executed similarly to the case of FIG. 21. Thus, the imaging device 200 can suppress reduction in the quality of the reconstruction of the 3D scene and the quality of rendering using the reconstruction.

### 6. Supplementary Note

### <Computer>

The above-described series of processing can be performed by hardware or software. In a case where the series of processing is executed by the software, a program that forms the software is installed in a computer. Here, examples of the computer include, for example, a computer that is built in dedicated hardware, a general-purpose personal computer that can perform various functions by being installed with various programs, and the like.

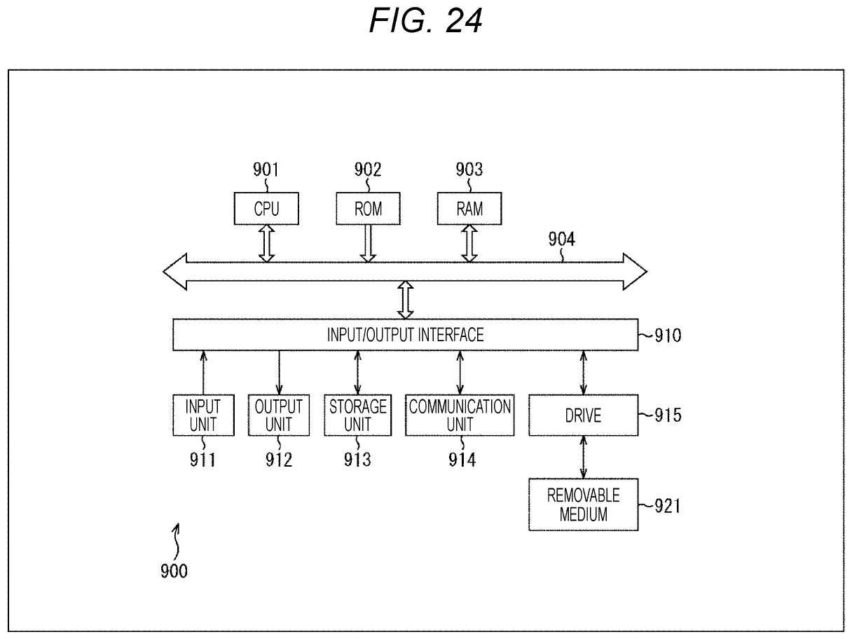

FIG. 24 is a block diagram illustrating a configuration example of the hardware of the computer that executes the above-described series of processing by the program.

In a computer 900 illustrated in FIG. 24, a central processing unit (CPU) 901, a read only memory (ROM) 902, and a random access memory (RAM) 903 are mutually connected via a bus 904.

Furthermore, an input/output interface 910 is also connected to the bus 904. To the input/output interface 910, an input unit 911, an output unit 912, a storage unit 913, a communication unit 914, and a drive 915 are connected.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. The RAM 903 also appropriately stores data and the like necessary for the CPU 901 to execute various types of processing.

A program executed by the computer can be applied by being recorded on the removable medium 921 as a package medium, or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

### <Applicable Target of Present Technology>

The present technology may be applied to any configuration. For example, the present technology may be applied to various electronic devices.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing where a plurality of devices shares responsibilities and jointly executes processing over a network. For example, the present technology may be implemented in a cloud service that provides a service related to an image (moving image) to any terminal such as a computer, an audio visual (AV) device, a portable information processing terminal, or an Internet of things (IoT) device.

Note that, in the present specification, a system means a set of a plurality of components (devices, modules (parts) and the like), and it does not matter whether or not all the components are in the same housing. Thus, a plurality of devices stored in different housings and connected via a network and one device in which a plurality of modules is stored in one housing are both systems.

<Field and Application to which Present Technology is Applicable>

The system, device, processing unit and the like to which the present technology is applied can be used in any field such as traffic, medical care, crime prevention, agriculture, livestock farming, mining, beauty care, factory, home appliance, weather, and natural surveillance, for example. Furthermore, application thereof is also arbitrary.

### <Others>

Note that, in the present specification, a “flag” is information for identifying a plurality of states, and includes not only information used for identifying two states of true (1) and false (0) but also information capable of identifying three or more states. Thus, a value that may be taken by the “flag” may be, for example, a binary of 1/0 or a ternary or more. That is, the number of bits forming this “flag” is any number, and may be one bit or a plurality of bits. Furthermore, identification information (including the flag) is assumed to include not only the identification information in a bit stream but also difference information of the identification information with respect to certain reference information in the bit stream, and thus, in the present specification, the “flag” and “identification information” include not only the information but also the difference information with respect to the reference information.

Furthermore, various kinds of information (such as metadata) related to coded data (a bit stream) may be transmitted or recorded in any form as long as it is associated with the coded data. Here, the term “associating” means, when processing one data, allowing other data to be used (to be linked), for example. That is, the pieces of data associated with each other may be combined as one data or may be treated as individual pieces of data. For example, information associated with the coded data (image) may be transmitted on a transmission path different from that of the coded data (image). Furthermore, for example, the information associated with the coded data (image) may be recorded in a recording medium different from that for the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associate” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, as long as the configuration and operation of the entire system are substantially the same, a part of the configuration of a certain device (or processing unit) may be included in the configuration of another device (or another processing unit).

Furthermore, for example, the above-described programs may be executed in any device. In this case, the device is only required to have a necessary function (functional block or the like) and obtain necessary information.

Furthermore, for example, each step in one flowchart may be executed by one device, or may be executed by being shared by a plurality of devices. Moreover, in a case where a plurality of pieces of processing is included in one step, the plurality of pieces of processing may be performed by one device, or may be shared and performed by a plurality of devices. In other words, the plurality of pieces of processing included in one step can also be executed as pieces of processing of a plurality of steps. Conversely, processing described as a plurality of steps can also be collectively executed as one step.

Furthermore, for example, in a program executed by the computer, processing of steps describing the program may be executed in a time-series order in the order described in the present specification, or may be executed in parallel or individually at a required timing such as when a call is made. That is, the pieces of processing of the respective steps may be executed in an order different from the above-described order as long as there is no contradiction. Moreover, processing of steps describing the program may be executed in parallel with processing of another program, or may be executed in combination with processing of another program.

Furthermore, for example, a plurality of technical elements included in the present technology can be independently implemented alone as long as no contradiction occurs. Of course, any plurality of technical elements thereof can be implemented in combination. For example, a part or all of the present technology described in any of the embodiments can be implemented in combination with a part or all of the present technology described in other embodiments. Furthermore, a part or all of any of the present technology described above can be implemented together with another technology that is not described above.

Note that the present technology may also provide the following configurations.
(1) An information processing device including:
a pose estimation unit that estimates a camera pose for each of frames of a moving image obtained by imaging of an object; and
a learning unit that performs learning of a neural network that approximates a radiance field expressing a scene in a space including the object by a color in each of directions at each of positions in the space and opacity at each position in the space by using the moving image and the camera pose estimated.
(2) The information processing device according to (1), in which
the pose estimation unit uses images of some consecutive frames of the moving image including a target frame for which the camera pose is estimated, as neighboring images captured in the vicinity of each other, and estimates the camera pose for the target frame.
(3) The information processing device according to (2), in which
the pose estimation unit sets the images of the frames consecutive in a display order as the neighboring images on the basis of display order information that is added to the moving image and indicates the display order of the frames.
(4) The information processing device according to (3), in which
the pose estimation unit sets the images of a number of the frames as the neighboring images, the number being designated by number-of-images information, on the basis of the number-of-images information that is added to the moving image and designates the number of images.
(5) The information processing device according to (4), in which
the pose estimation unit estimates the camera pose on the basis of constraint information that is added to the moving image and indicates a constraint between the neighboring images.
(6) The information processing device according to (5), in which
the constraint information indicates a maximum value of a distance between the neighboring images.
(7) The information processing device according to (5) or (6), in which
the constraint information indicates a maximum value of a rotation angle between the neighboring images.
(8) The information processing device according to any of (1) to (7), in which
the learning unit further performs the learning on the basis of additional information added to the moving image.
(9) The information processing device according to (8), in which
the additional information includes information regarding a rolling shutter of an imaging unit that has generated the moving image.
(10) The information processing device according to (8) or (9), in which
the additional information includes information indicating a shutter system of an imaging unit that has generated the moving image.
(11) The information processing device according to any of (8) to (11), in which
the additional information includes structure information regarding structure of an imaging unit that has generated the moving image.
(12) The information processing device according to (11), in which
the structure information includes information indicating a model of a parameter of the imaging unit.
(13) The information processing device according to (11) or (12), in which
the structure information includes information indicating internal parameters of the imaging unit.
(14) The information processing device according to (13), in which
the structure information includes information indicating errors of the internal parameters.
(15) The information processing device according to any of (11) to (14), in which
the structure information includes identification information on the imaging unit.

(16) The information processing device according to any of (8) to (15), in which
the additional information includes motion information regarding motion of an imaging unit that has generated the moving image.
(17) The information processing device according to (16), in which
the motion information includes information regarding a range of a pose of the imaging unit.
(18) The information processing device according to (16) or (17), in which
the motion information includes information indicating an error of a pose of the imaging unit.
(19) The information processing device according to any of (16) to (18), in which
the motion information includes information indicating acceleration of the imaging unit.
(20) The information processing device according to any of (8) to (19), in which
the additional information includes imaging information regarding imaging for generating the moving image.
(21) The information processing device according to (20), in which
the imaging information includes information indicating setting of a shutter speed in the imaging.
(22) The information processing device according to (20) or (21), in which
the imaging information includes information indicating a setting of ISO sensitivity in the imaging.
(23) The information processing device according to any of (20) to (22), in which
the imaging information includes information indicating an aperture value in the imaging.
(24) The information processing device according to any of (20) to (23), in which
the imaging information includes information regarding color temperature of the moving image or information indicating a white balance adjustment value in the imaging.
(25) The information processing device according to any of (20) to (24), in which
the imaging information includes information indicating an imaging time at which the imaging is performed.
(26) The information processing device according to any of (1) to (25), further including
an inference unit that receives pose information on a desired viewpoint as an input, performs inference using a result of the learning performed by the learning unit, and generates a rendered image corresponding to the viewpoint.
(27) The information processing device according to any of (1) to (26), further including
a decoding unit that decodes a bit stream and generates the moving image, in which
the pose estimation unit estimates the camera pose for each frame of the moving image generated by the decoding unit, and
the learning unit performs the learning using the moving image generated by the decoding unit and the camera pose estimated by the pose estimation unit.
(28) The information processing device according to (27), further including
a reception unit that receives the bit stream, in which
the decoding unit decodes the bit stream received by the reception unit.
(29) The information processing device according to any of (1) to (26), further including
an imaging unit that images the object and generates the moving image, in which
the pose estimation unit estimates the camera pose for each frame of the moving image generated by the imaging unit, and
the learning unit performs the learning using the moving image generated by the imaging unit and the camera pose estimated by the pose estimation unit.
(30) The information processing device according to (29), further including
an additional information generation unit that generates additional information to be used for any one or both of estimation of the camera pose and the learning, and adds the additional information to the moving image generated by the imaging unit, in which
the pose estimation unit estimates the camera pose for each frame of the moving image generated by the imaging unit by using the additional information generated by the additional information generation unit, and
the learning unit performs the learning using the moving image generated by the imaging unit, the camera pose estimated by the pose estimation unit, and the additional information generated by the additional information generation unit.
(31) An information processing method including:
estimating a camera pose for each of frames of a moving image obtained by imaging of an object; and
performing learning of a neural network that approximates a radiance field expressing a scene in a space including the object by a color in each of directions at each of positions in the space and opacity at each position in the space by using the moving image and the camera pose estimated.
(41) An information processing device including:
an imaging unit that images an object to generate a moving image;
an additional information generation unit that generates additional information to be used for any one or both of estimation of a camera pose for each of frames of the moving image, and learning of a neural network that approximates a radiance field expressing a scene in a space including the object by a color in each of directions at each of positions in the space and opacity at each position in the space, to add the additional information to the moving image; and
an encoding unit that encodes the moving image to which the additional information is added to generate a bit stream.
(42) The information processing device according to (41), in which
the encoding unit stores the additional information in supplemental enhancement information (SEI) of the bit stream.
(43) The information processing device according to (41) or (42), in which
the additional information includes information regarding a rolling shutter of the imaging unit.
(44) The information processing device according to any of (41) to (43), in which
the additional information includes information indicating a shutter system of the imaging unit.
(45) The information processing device according to any of (41) to (44), in which
the additional information includes structure information regarding structure of the imaging unit.
(46) The information processing device according to (45), in which
the structure information includes information indicating a model of a parameter of the imaging unit.
(47) The information processing device according to (45) or (46), in which
the structure information includes information indicating internal parameters of the imaging unit.
(48) The information processing device according to (47), in which
the structure information includes information indicating errors of the internal parameters.
(49) The information processing device according to any of (45) to (48), in which
the structure information includes identification information on the imaging unit.
(50) The information processing device according to any of (41) to (49), in which
the additional information includes motion information regarding motion of the imaging unit.
(51) The information processing device according to (50), in which
the motion information includes information regarding a range of a pose of the imaging unit.
(52) The information processing device according to (50) or (51), in which
the motion information includes information indicating an error of a pose of the imaging unit.
(53) The information processing device according to any of (50) to (52), in which
the motion information includes information indicating acceleration of the imaging unit.
(54) The information processing device according to any of (41) to (53), in which the additional information includes imaging information regarding imaging of the object.
(55) The information processing device according to (54), in which
the imaging information includes information indicating a setting of a shutter speed in the imaging.
(56) The information processing device according to (54) or (55), in which
the imaging information includes information indicating a setting of ISO sensitivity in the imaging.
(57) The information processing device according to any of (54) to (56), in which
the imaging information includes information indicating an aperture value in the imaging.
(58) The information processing device according to any of (54) to (57), in which the imaging information includes information regarding color temperature of the moving image or information indicating a white balance adjustment value in the imaging.
(59) The information processing device according to any of (54) to (58), in which
the imaging information includes information indicating an imaging time at which the imaging is performed.
(60) An information processing method including:
imaging an object to generate a moving image;
generating additional information to be used for any one or both of estimation of a camera pose for each of frames of the moving image, and learning of a neural network that approximates a radiance field expressing a scene in a space including the object by a color in each of directions at each of positions in the space and opacity at each position in the space, to add the additional information to the moving image; and
encoding the moving image to which the additional information is added to generate a bit stream.

### REFERENCE SIGNS LIST

100 Information processing system
110 Network
111 Imaging device
112 Information processing device
121 Imaging unit
122 Additional information generation unit
123 Encoding unit
124 Storage unit
125 Communication unit
151 Communication unit
152 Storage unit
153 Decoding unit
154 Pose estimation unit
155 Learning unit
156 Inference unit
200 Imaging device
900 Computer

1. An information processing device comprising:
a pose estimation unit that estimates a camera pose indicating a posture of a camera for each of frames of a moving image obtained by imaging of an object; and
a learning unit that performs learning of a neural network that approximates a radiance field expressing a scene in a space including the object by a color in each of directions at each of positions in the space and opacity at each position in the space by using the moving image and the camera pose estimated,
wherein
the pose estimation unit uses images of some consecutive frames of the moving image including a target frame for which the camera pose is estimated, as neighboring images captured in a vicinity of each other, and estimates the camera pose for the target frame.

2. The information processing device according to claim 1, wherein
the pose estimation unit sets the images of the frames consecutive in a display order as the neighboring images on a basis of display order information that is added to the moving image and indicates the display order of the frames.

3. The information processing device according to claim 2, wherein
the pose estimation unit sets the images of a number of the frames as the neighboring images, the number being designated by number-of-images information, on a basis of the number-of-images information that is added to the moving image and designates a number of images.

4. The information processing device according to claim 3, wherein
the pose estimation unit estimates the camera pose on a basis of constraint information that is added to the moving image and indicates a constraint between the neighboring images.

5. The information processing device according to claim 4, wherein
the constraint information indicates a maximum value of a distance between the neighboring images.

6. The information processing device according to claim 4, wherein
the constraint information indicates a maximum value of a rotation angle between the neighboring images.

7. The information processing device according to claim 1, wherein
the learning unit further performs the learning on a basis of additional information added to the moving image.

8. The information processing device according to claim 7, wherein
the additional information includes information regarding a rolling shutter of an imaging unit that has generated the moving image.

9. The information processing device according to claim 7, wherein
the additional information includes information indicating a shutter system of an imaging unit that has generated the moving image.

10. The information processing device according to claim 7, wherein
the additional information includes structure information regarding structure of an imaging unit that has generated the moving image.

11. The information processing device according to claim 7, wherein
the additional information includes motion information regarding motion of an imaging unit that has generated the moving image.

12. The information processing device according to claim 7, wherein
the additional information includes imaging information regarding imaging for generating the moving image.

13. The information processing device according to claim 1, further comprising
an inference unit that receives pose information on a desired viewpoint as an input, performs inference using a result of the learning performed by the learning unit, and generates a rendered image corresponding to the viewpoint.

14. The information processing device according to claim 1, further comprising
a decoding unit that decodes a bit stream and generates the moving image, wherein
the pose estimation unit estimates the camera pose for each frame of the moving image generated by the decoding unit, and
the learning unit performs the learning using the moving image generated by the decoding unit and the camera pose estimated by the pose estimation unit.

15. The information processing device according to claim 1, further comprising
an imaging unit that images the object and generates the moving image, wherein
the pose estimation unit estimates the camera pose for each frame of the moving image generated by the imaging unit, and
the learning unit performs the learning using the moving image generated by the imaging unit and the camera pose estimated by the pose estimation unit.

16. The information processing device according to claim 15, further comprising
an additional information generation unit that generates additional information to be used for any one or both of estimation of the camera pose and the learning, and adds the additional information to the moving image generated by the imaging unit, wherein
the pose estimation unit estimates the camera pose for each frame of the moving image generated by the imaging unit by using the additional information generated by the additional information generation unit, and
the learning unit performs the learning using the moving image generated by the imaging unit, the camera pose estimated by the pose estimation unit, and the additional information generated by the additional information generation unit.

17. An information processing method comprising:
estimating a camera pose indicating a posture of a camera for each of frames of a moving image obtained by imaging of an object to estimate the camera pose for a target frame by using images of some consecutive frames of the moving image including the target frame for which the camera pose is to be estimated as neighboring images captured in a vicinity of each other when estimating the camera pose for each frame; and
performing learning of a neural network that approximates a radiance field expressing a scene in a space including the object by a color in each of directions at each of positions in the space and opacity at each position in the space by using the moving image and the camera pose estimated.

18. An information processing device comprising:
an imaging unit that images an object to generate a moving image;
an additional information generation unit that generates additional information to be used for any one or both of estimation of a camera pose indicating a posture of a camera for each of frames of the moving image, and learning of a neural network that approximates a radiance field expressing a scene in a space including the object by a color in each of directions at each of positions in the space and opacity at each position in the space, to add the additional information to the moving image; and
an encoding unit that encodes the moving image to which the additional information is added to generate a bit stream.

19. The information processing device according to claim 18, wherein
the encoding unit stores the additional information in supplemental enhancement information (SEI) of the bit stream.

20. An information processing method comprising:
imaging an object to generate a moving image;
generating additional information to be used for any one or both of estimation of a camera pose indicating a posture of a camera for each of frames of the moving image, and learning of a neural network that approximates a radiance field expressing a scene in a space including the object by a color in each of directions at each of positions in the space and opacity at each position in the space, to add the additional information to the moving image; and
encoding the moving image to which the additional information is added to generate a bit stream.
